(19) United States
(12) Patent Application Publication
(10) Pub. No.: US 2019/0354592 A1
(43) Pub. Date: Nov. 21, 2019

(54) Automated systems and methods for providing bidirectional parallel language recognition and translation processing with machine speech production for two users simultaneously to enable gapless interactive conversational communication

(71) Applicants: Sharat Chandra Musham, Austin, TX (US); Pranitha Paladi, Austin, TX (US); Rey Moulton, Brooklyn, NY (US)

(72) Inventors: Sharat Chandra Musham, Austin, TX (US); Pranitha Paladi, Austin, TX (US); Rey Moulton, Brooklyn, NY (US)

(21) Appl. No.: 15/981,005

(22) Filed: May 16, 2018

(51) Int. Cl. G06F 17/28; G10L 15/00; G10L 15/18; G10L 13/02

(52) U.S. Cl. CPC G06F 17/289; G10L 13/02; G10L 15/1822; G10L 15/005

(57) ABSTRACT

A novel system and multi-device invention that provide a means to communicate in real-time (conversationally) between two or more individuals, regardless of each individual's preferred or limited mode of transmission or receipt (by gesture, by voice—in Mandarin to German to Farsi, by text in any major language, and via machine learning, eventually by dialect).

Systems and methods for conversational communication between two individuals using multiple language modes (e.g. visual language and verbal language) through the use of a worn device (for hands-free language input capability) are provided. Information may be stored in memory regarding user preferences, as well as various language databases—visual to verbal to textural- or the system can determine and adapt to user (primary and second) preferences and modes based on direct input, and adapt. Core processing for worn device can be performed 1) off-device via cloud processing through wireless transmission, 2) on-board, or a 3) mix of both, depending on the embodiment, and location of use, for example if the user is out of range from access to a high-speed wireless network and needs to rely more on on-board processing, or to maintain conversational speed dual/real-time translation and conversion.

### CROSS REFERENCES TO RELATED APPLICATIONS

None.

### BACKGROUND

### Field of Invention

The present invention is directed generally to communication systems and machine translation of human language.

### Prior Art

The following is a tabulation of some prior art that presently appears relevant:

U.S. Patents

| Pat. No. | Issue Date | Patentee |
|---|---|---|
| Pat. 9,195,652 | 2005 Feb. 5 | Custer, et al. |
| Pat. 9,507,774 | 2016 Nov. 16 | Furihata, et al. |
| Pat. 8,868,430 | 2014 Oct. 21 | Burvall, et al. |
| Pat. 9,600,474 | 2017 Mar. 17 | Cuthbert, et al |
| Pat. 5,987,401 | 1999 Nov. 16 | Trudeau |
| Pat. 9,235,567 | 2016 Jan. 12 | Mylonakis, et al. |
| Pat. 9,298,701 | 2016 Mar. 29 | Fuji, et al. |
| Pat. 9,514,377 | 2016 Dec. 6 | Cuthbert, et al. |

Communication is the act of conveying intended meanings from one entity or group to another through the use of mutually understood signs and semiotic rules. The main steps inherent to all communication are¹: ¹C. E. Shannon. “A Mathematical Theory of Communication”, Math.harvard.edu. Retrieved 2018-1-05.
1. The formation of communicative motivation or reason.
2. Message composition (further internal or technical elaboration on what exactly to express).
3. Message encoding (for example, into digital data, written text, speech, pictures, gestures and so on).
4. Transmission of the encoded message as a sequence of signals using a specific channel or medium.
5. Noise sources such as natural forces and in some cases human activity (both intentional and accidental) begin influencing the quality of signals propagating from the sender to one or more receivers.
6. Reception of signals and reassembling of the encoded message from a sequence of received signals.
7. Decoding of the reassembled encoded message.
8. Interpretation and making sense of the presumed original message.

In human natural language, one consideration outside of literal words (regardless of language used for encoding those words), in message encoding (#3 above) is in the portion of messaging from one human to another that cannot be discerned from words alone, which falls under the category of paralanguage. [0006] Paralanguage is a component of meta-communication that may modify or nuance meaning, or convey emotion, such as prosody, pitch, volume, intonation etc. It is sometimes defined as relating to nonphonemic properties only. Paralanguage may be expressed consciously or unconsciously. The study of paralanguage is known as paralinguistics, and was invented by George L. Trager in the 1950s, while he was working at the Foreign Service Institute of the Department of State. His work has served as a basis for all later research, especially those investigating the relationship between paralanguage and culture (since paralanguage is learned, it differs by language and culture). A good example is the work of John J. Gumperz on language and social identity, which specifically describes paralinguistic differences between participants in intercultural interactions2. The film Gumperz made for BBC in 1982, Multiracial Britain: Crosstalk, does a particularly good job of demonstrating cultural differences in paralanguage, and the impact these have on relationships.

Paralinguistic information, because it is phenomenal, belongs to the external speech signal (Ferdinand de Saussure's parole) but not to the arbitrary conventional code of language (Saussure's langue). The paralinguistic properties of speech play an important role in human communication. There are no utterances or speech signals that lack paralinguistic properties, since speech requires the presence of a voice that can be modulated. This voice must have some properties, and all the properties of a voice as such are paralinguistic.

However, the distinction linguistic vs. paralinguistic applies not only to speech but to writing and sign language as well, and it is not bound to any sensory modality. Even vocal language has some paralinguistic as well as linguistic properties that can be seen such as lip reading.

Conversation and Dialogue versus Communication via Sharing Parceled Information (e.g. Short Message Service and Email). One type of conversation is discussion: sharing opinions on subjects that are thought of during the conversation. In polite society the subject changes before discussion becomes dispute or controversial. For example, if theology is being discussed, no one is insisting a particular view be accepted.

Discussions are truly dialogue based, between two individuals, whereby the ideas and opinions embedded in the overall discussion may change, be built upon, or deemed completed by the discussion itself, before other ideas or models are introduced relating to the overall theme or purpose of the dialogue, which can be introduced by either individual. Dialogue is based on the Greek words “dia”, for passing through (such as a single concept or- dialogue-between two people versus separate ego-centric based debate or argument where each “side” uses rhetorical tools of persuasion to “win” their side), and “logos” which based on a Greek word whose literal meaning is “ground”, “plea”, “opinion”, “expectation”, “word”, “speech”, “account”, “reason”, “proportion”, “discourse”, but it became a technical term in philosophy as a term for a principle of order and knowledge; and by the Stoics as a broader term for active reason pervading and animating the universe. It was conceived of as material, and is usually identified with God or Nature. The Stoics referred to the seminal logos (“logos spermatikos”), or the law of generation in the universe, which was the principle of the active reason working in inanimate matter. In other words, it is a pre-existing, and inalterable system of truth that exists, and humans discover pieces of it, much through dialogue, which is sharing and clarifying between two individuals who can contribute pieces of logos to the dialogue that they know to be true, to help expanding their understanding of the larger logos together.

Indeed, this is the original meaning and original purpose behind dialogue in general, and many would blame rhetoric, specifically its sub-branch of argument, as perverting the original purpose of dialogue and empowering individuals to manipulate language through self-serving abuse of rhetorical tools to “persuade” by “winning” an argument, versus exploring and learning together in a dialogue. Nevertheless, for the purposes of clarification for the background of this application, our focus is on productive and contributory dialogue.

In a true (productive) dialogue, individuals only have time to process the meaning of what someone has said and respond directly, with little time to add persuasive information to support a self-serving agenda (e.g. argument), and per the (often unspoken) rule of good form in a dialogue, each, participant respond to the idea or concept put before them with an additive or corresponding idea, through a sentence or two of descriptive words versus multiple sequential sentences or paragraphs. However, with current digital forms of mediated communication, from SMS text to voice, when needing to be translated, for the convenience of the “sender” and “receiver” based on the lag time of having to submit input and process “whole” before having a translated message that can be sent (and then processed mentally by the receiver), and based on the human behavioral norm of self-utility, just as is seen in formal debates, a single themed discussion between two people given time to make rhetorically augmented responses (versus direct unmitigated responses) is an argument, or zero sum game, and not a collaborative conversation, or positive sum game, where dialogue serves to further the understanding and awareness of both (or all) participants.

A direct discussion reduces the likelihood of rhetorical (individual agenda based) modification of a response, indeed, information that is sent back and forth, with time drag of completion of message before sending, and in the case of translated words, the additional time to complete a complete message grouping versus individual point by one individual before sending it, and then the added time in between communication sending and reception and then processing by the receiver before responding, allowing for intended or unintended rephrasing or agenda-based response, is why up to now, tech enabled distance message sending (exacerbated by packet translation between two individuals whose primary language for communicating are different) is limited to mediated debate or correspondence, and not direct dialogue.

The ideal of productive dialogue is to create a thought and feeling construct that is greater in understanding than the individual's involved could achieve on their own. In this sense, a direct dialogue is greater in meaning (ideally, if it is productive) than its individual parts and participant understanding before engaging in a dialogue. The best description for this type of productive, evolving dialogue is by physicist, David Bohm. A Bohm Dialogue (also known as Bohmian Dialogue or “Dialogue in the Spirit of David Bohm”) is a freely flowing group conversation (minimum two people) in which participants attempt to reach a common understanding, experiencing everyone's point of view fully, equally and nonjudgmentally. This can lead to new and deeper understanding. This deeper understanding is the function of this type of communication, which is specifically a conversation, and thus, is a functional conversation, designed to convey information in order to help achieve an individual or group goal.

Or, a wonderful description of the difference between sending messages back and forth which also provides additional time for responses to be worded for persuasion to their owner's own personal agenda and point of view, which is by its nature less filtered and more honest is:

“Because the nature of Dialogue is exploratory, its meaning and its methods continue to unfold. No firm rules can be laid down for conducting a Dialogue because its essence is learning—not as the result of consuming a body of information or doctrine imparted by an authority, nor as a means of examining or criticizing a particular theory or program, but rather as part of an unfolding process of creative participation between peers.”

Conversations can be divided into four categories according to their major subject content:

Subjective ideas, which often serve to extend understanding and awareness.

Objective facts, which may serve to consolidate a widely held view.

Other people (usually absent), which may be critical, competitive, or supportive.

Oneself, which sometimes indicate attention-seeking behavior or can provide relevant information about oneself to participants in the conversation.

Direct, interactive conversation between two individuals. We will detail, using formal conversational science references, the structural difference between conversational communication (also referred to as contributory or productive dialogue when limited to two people), but will start with the simplest way to understand what it is, but defining what it is not. A ritualized exchange such as a mutual greeting is not a conversation, and an interaction that includes a marked status differential (such as a boss giving orders) is also not a conversation. An interaction with a tightly focused topic or purpose is also not a conversation3, even though the adjective that in common usage separates “conversation” from general communication is “interactive”, as in direct response, unmitigated 2 way communication. But we will show how the structure and core productive output of conversation itself is completely different than any other forms of communication.

For close to a decade, machine translation of human language in textural form has improved to the point where initially words in most major languages can be translated from one language to another accurately in seconds with normal personal computer processing power, to whole paragraphs with grammatical accuracy via web and server-client processing over the same duration of time. A good example of a leading mainstream program is Google Translate, which now even serves as a plugin for web pages, accurately translating full web pages in a few seconds, from very different languages, such as from Russian to English. This is often an unnoticed boon to people across the world, in individual communication, and a major example of technological democratization, previously done manually through professional translators in limited occasions and mostly for government or international business contexts.

There have also been advances in translating between types of communication, for example, verbal and textural communication.

Regardless of mode or type of communication, such as text via chat or short message services (SMS) or email, or voice, and language, none of these technologies or devices enable full-speed interactive conversation between individuals speaking different languages. For example, while today multiple words can be quickly translated in a few seconds versus individual words, the technology is limited in that it only provides one way communication in semi-bulk data, which must be understood by a receiver, processed (by their brain), then a response must be prepared before it is submitted for translation and sent back to the other person in their language.

Conversational communication is very different and had many advantages over prepared and static communication. For comparison, we will refer to current enabled translated communication as “transmitted communication idea or concept groupings” versus true conversation. As per Gordon Task4², scientist and conversational theory expert who developed this discipline of semiotics over three decades and whose work is still referenced most today regarding conversational communication, there are several differences and advantages of conversation versus other types or modes of communication (such as letters or email), including: ²Gordon Pask, Heinz von Foerster's Self-Organization, the Progenitor of Conversation & Interaction Theories, 1996.

Immediate response. When people communicate each other in person, they can get a response immediately without misunderstanding. During the conversation, people can not only hear a response from others, also see how they are feeling; people can guess what will take place next, how the conversation is about, which is very important to have a successful talk.

Expression of feelings: Using conversational communication helps people express their feelings, ideas much better. Instead of using words only when people choose letters or emails, people can tonality in verbal language in order to show their opinions, which according to scientists as part of “non-verbal” communication accounts for up to 70% of actual meaning being conveyed by overall content of communication5. This is where paralinguistic meaning, such as the tone, pitch, pace of a sender's voice can convey significant shading or meaning in addition to the words being used.

Feedback and evolution of what is being communicated: Conversation provides each participant with a much better opportunity for adjustment, both in reaction (clarification or supplemental idea) which are only possible in direct conversation versus piecemeal communication, where both individuals respond versus react directly.

Conversation to coordinate: Coordinating our action in ways that are mutually beneficial. Anytime we negotiate one favor for another, we use conversation to reach an agreement to transact.

Collaboration: Coordination of action assumes relatively clear goals, but many times social interaction involves the negotiation or modification of goals. Conversation is a requisite for agreeing on goals, as well as for agreeing upon and coordinating our actions6.

Currently, language translation devices, programs, technologies do not enable actual two-way gapless conversation and are typically limited to communicating around one topic to clarify that topic through presenting in the language of a receiver, and receiving a response either acknowledging or adding to what was just presented. These are the steps, visualized, including the machine translation steps:

In addition, so we can discuss the parsing of verbal information with exactitude, we will introduce a core definition of “parts” of words in this background summary as to a morpheme. A morpheme is the smallest meaningful morphological unit of a language that cannot be further divided, for example, in, come, -ing, are morphemes that together form the word “incoming”.

There are several benefits of conversation versus parceled single-response/topic voice or text communication, all primarily around human conversation allows for a single evolving conversation with two people directly modifying its structure in real time, improving, evolving, and creating new information quickly, versus responding along a linear single topic path:

This first diagram, first introduced by mathematics and machine language scientist Gordon Pask in the 1950's shows the most elemental difference and advantage of conversation over general communication and two-way messaging. With T=“Topic” (or concept, or complete idea), two individuals contributing separate ideas in dialogue directly can create a third concept, or more poetically, as per Bohm, “broaden their shared awareness of the topic area”. This is the simplest and clearest difference structurally to a 2 way message based communication format, such as email.

While conversation, and additive and evolutionary idea or collaborative model-building structures from conversation are achieved through face-to-face human to human dialogues and even in a slightly more limited form (without the body language and facial expressions of face-to-face paralinguistic content additions) through direct phone calls, between two individuals using the same language, they are not possible using other formats for conveyance, such as email, or even text, which are at best (typically) medium-length parceled information sharing. Of course, even “real-time” voice to voice translators as currently embodied, and premised on the technical standard of batch processing and then delivery, cannot be used for enabling a truly productive conversation, though they are laudable for their efforts in breaking down language barriers for essential information and short-form communication if still focused on unidirectional expression/communication.

For two individuals to have a productive, aka “Bohm-like” conversation, it is necessary to have a direct feedback mechanism (single language expressed most rapidly through speech), and allow for mental processing of content while each participant is speaking to the other, so that a participant can respond directly to the topic, idea or concept they have just understood, without added time for formulating additional information for rhetorical use, and also to enjoy the “single communication” vehicle of conversation versus parceled message communication such as from the direct understanding and direct response from their verbalized response from another participant.

Language Translation: Background, what exists, prior art, limitations. One of the greatest advances in globalization and communication over the last decade has been in the capabilities of language translation, from larger databases of languages outside the traditional realm of “main” languages such as English, Spanish, French, the languages most often taught in American public schools, but more recently the advances in language translation processes themselves, enhancing both accuracy and speed, and now depth of data, such as going from text to text to voice to text and now even—in limited form—voice to voice translation. Of course, the underlying scientific and technical advances are in machine translation for natural language processing (such as human language), and not in human language itself. And, the fields of artificial intelligence (AI) and human-computer interaction (HCl) are influencing each other more than ever before, in this field of machine translation. Widely used systems such as Google Translate, Facebook Graph Search, and RelateIQ hide the complexity of large-scale AI systems behind intuitive interfaces.

Since the 1960s, HCl has often been ascendant when setbacks in AI occurred, with successes and failures in the two fields redirecting mindshare and research funding. Although early figures such as Allen Newell and Herbert Simon made fundamental contributions to both fields, the competition and relative lack of dialogue between AI and HCl are curious. Both fields are broadly concerned with the connection between machines and intelligent human agents. What has changed in the last few years is the deployment and adoption of user-facing AI systems. These systems need interfaces, leading to natural meeting points between the two fields. Nowhere is this intersection more apropos than in natural language processing (NLP). Language translation is a concrete example. In practice, professional translators use suggestions from machine aids to construct final, high-quality translations. Increasingly, human translators are incorporating the output of machine translation (MT) systems such as Google Translate into their work. While still fallible with translation mistakes, and still focused on one-way chunks of information translation, this type of system was first envisioned in the early 1950s and that developments in translation research figured significantly in the early dialogue between AI and HCl. The failed dreams of early MT researchers are not merely historical curiosities, but illustrations of how intellectual biases can marginalize pragmatic solutions, in this case a human-machine partnership for translation.

A Short History of Interactive Machine Translation

Machine translation as an application for digital computers predates both computational linguistics and artificial intelligence, fields of computer science within which it is now classified. The term artificial intelligence (AI) first appeared in a call for participation for a 1956 conference at Dartmouth College organized by McCarthy, Minsky, Rochester, and Shannon. But by 1956, MT was a very active research area, with the 1954 Georgetown MT demonstration receiving widespread media coverage. The field of computational linguistics grew out of early research on machine translation. MT research was oriented toward cross-language models of linguistic structure; with parallel theoretical developments by Noam Chomsky in generative linguistics exerting some influence21. The stimuli for MT research were the invention of the general-purpose computer during World War II and the advent of the Cold War. In an oft-cited March 1947 letter, Warren Weaver—a former mathematics professor, then director of the Natural Sciences division at the Rockefeller Foundation—asked Norbert Wiener of the Massachusetts Institute of Technology (MIT) about the possibility of computer-based translation: “Recognizing fully . . . the semantic difficulties because of multiple meanings . . . I have wondered if it were unthinkable to design a computer which would translate . . . one naturally wonders if the problem of translation could conceivably be treated as a problem in cryptography. When I look at an article in Russian, I say ‘This is really written in English, but it has been coded in some strange symbols. I will now proceed to decode.’” Wiener's response was skeptical and unenthusiastic, ascribing difficulty to the extensive “connotations” of language. What is seldom quoted is Weaver's response on May 9th of that year. He suggested a distinction between the many combinatorial possibilities with a language and the smaller number that are actually used: “It is, of course, true that Basic [English]³ puts multiple uses on an action verb such as ‘get’. But even so, the two-word combinations such as get up, get over, get back, etc., are, in Basic, not really very numerous. Suppose we take a vocabulary of 2,000 words, and admit for good measure all the two-word combinations as if they were single words. The vocabulary is still only four million: and that is not so formidable a number to a modern computer, is it?”³“Basic English” was a controlled language, created by Charles Kay Ogden as a medium for international exchange popular at the time.

Weaver was suggesting a distinction between theory and use that would eventually take root in the empirical revolution of the 1990s: an imperfect linguistic model could suffice given enough data. The statistical MT techniques described at the end of this article are in this empirical tradition.

By 1951 MT research was underway, and Weaver had become a director of the National Science Foundation (NSF). An NSF grant—possibly under the influence of Weaver—funded the appointment of the Israeli philosopher Yehoshua Bar-Hillel to the MIT Research Laboratory of Electronics (Hutchins, 1997, p. 220)19. That fall Bar-Hillel toured the major American MT research sites at the University of California-Los Angeles, the RAND Corporation, U.C. Berkeley, the University of Washington, and the University of Michigan-Ann Arbor. He prepared a survey report1 for presentation at the first MT conference, which he convened the following June.

That report contains two foundational ideas. First, Bar-Hillel anticipated two use cases for “mechanical translation.” The first is dissemination: “One of these is the urgency of having foreign language publications, mainly in the fields of science, finance, and diplomacy, translated with high accuracy and reasonable speed”. The dissemination case is distinguished by a desired quality threshold. The other use case is assimilation: “Another is the need of high-speed, though perhaps low-accuracy, scanning through the huge printed output.”⁴ ⁴Excerpt from letter from Warren Weaver to Norbert Wiener. May 9, 1947

Bar-Hillel observed that the near-term achievement of “pure MT” was either unlikely or “achievable only at the price of inaccuracy.” He then argued in favor of mixed MT, “i.e., a translation process in which a human brain intervenes.” As for where in the pipeline this intervention should occur, Bar-Hillel recommended: “the human partner will have to be placed either at the beginning of the translation process or the end, perhaps at both, but preferably not somewhere in the midst of it. He then went on to define the now familiar terms pre-editor, for intervention prior to MT, and post-editor for intervention after MT. The remainder of the survey deals primarily with this pre- and post-editing, showing a pragmatic predisposition that would be fully revealed a decade later. Having established terms and distinctions still in use today, Bar-Hillel returned to Israel in 1953 and took a hiatus from MT21. In 1958 the US Office of Naval Research commissioned Bar-Hillel to conduct another survey of MT research. That October he visited research sites in America and Britain, and collected what information was publicly available on developments in the Soviet Union. A version of his subsequent report circulated in 1959, but the revision that was published in 1960 attracted greater attention. Bar-Hillel's central argument in 1960 was that preoccupation with “pure MT”—his label for what was then called fully automatic high quality translation (FAHQT)—was “unreasonable” and that despite claims of imminent success, he “could not be persuaded of their validity.” He provided an appendix with a purported proof of the impossibility of FAHQT. The proof was a sentence with multiple senses (in italics) in a simple passage that is difficult to translate without extra-linguistic knowledge (“Little John was looking for his toy box. Finally he found it. The box was in the pen”). Fifty-four years later, Google Translate cannot translate this sentence correctly for many language pairs. Bar-Hillel outlined two paths forward: carrying on as before, or favoring some “less ambitious aim.” That less ambitious aim was mixed MT: As soon as the aim of MT is lowered to that of high quality translation by a machine-post-editor partnership, the decisive problem becomes to determine the region of optimality in the continuum of possible divisions of labor⁵. ⁵Ibid.

The Proper Role of Machines. The fixation on FAHQT at the expense of mixed translation indicated a broader philosophical undercurrent in the first decade of AI research. Those promoting FAHQT were advocates—either implicitly or explicitly—of the vision that computers would eventually rival and supplant human capabilities. Nobel Laureate Herbert Simon famously wrote in 1960 that “Machines will be capable, within twenty years, of doing any work that a man can do”. Bar-Hillel's proposals were in the spirit of the more skeptical faction, which believed machine augmentation of existing human facilities was a more reasonable and achievable goal.

Martin Kay and the First Interactive Machine Translation System. By the late 1960s, Martin Kay and colleagues at the RAND Corporation began to design a human-machine translation system, the first incarnation of which was called MIND. Their system which was never built included human intervention by monolingual editors during both source (syntactic) analysis and target generation (personal communication with Martin Kay, 7 Nov. 2014). MIND was consistent with Bar-Hillel's 1951 plan for pre-editors and post-editors. Kay went further with a 1980 proposal for a “translator's amanuensis,” which would be a “word processor [with] some simple facilities peculiar to translation”. Kay saw three benefits of user-directed MT. First, the system—now having the user's attention—would be better able to point out uncertain translations. Second, cascading errors could be prevented since the machine would be invoked incrementally at specific points in the translation process.

Third, the machine could record and learn from the interaction history. Kay advocated collaborative refinement of results: “the man and the machine are collaborating to produce not only a translation of a text but also a device whose contribution to that translation is being constantly enhanced”22. These three benefits would now be recognized as core characteristics of an effective mixed-initiative system. Kay's proposal had little effect on the commercial “translator workbenches” developed and evaluated during the 1980s, perhaps due to limited circulation of his 1980 memo (which would not be published until 199823).
However, similar ideas were being investigated at Brigham Young University as part of the Automated Language Processing (ALP) project. Started in 1971 to translate Mormon texts from English to other languages, ALP shifted emphasis in 1973 to machine-assisted translation0. The philosophy of the project was articulated by Alan Melby, who wrote that “rather than replacing human translators, computers will serve human translators”. ALP produced the Interactive Translation System (ITS), which allowed human interaction at both the source analysis and semantic transfer phases. But Melby found that in experiments, the time spent on human interaction was “a major disappointment,” because a 250-word document required about 30 minutes of interaction, which is “roughly equivalent to a first draft translation by a human translator.” He drew several conclusions that were to apply to most interactive systems evaluated over the following two decades: ITS did not yet aid the human translator enough to justify the engineering overhead, online interaction requires specially trained operators, further increasing overhead and most translators do not enjoy post-editing. ALP never produced a production system due to “hardware costs and the amount and difficulty of human interaction”. Kay and Melby intentionally limited the coupling between the MT system and the user; MT was too unreliable to be a constant companion. Church and Hovy in 1993 were the first to see an application of tighter coupling, even when MT output was poor. Summarizing user studies dating back to 1966, they described post-editing as an “extremely boring, tedious and unrewarding chore.” Then they proposed a “superfast typewriter” with an autocomplete text prediction feature that would “fill in the rest of a partially typed word/phrase from context.” A separate though related aid would be a “Cliff-note” mode in which the system would annotate source text spans with translation glosses. Both of these features were consistent with their belief that a good application of MT should “exploit the strengths of the machine and not compete with the strengths of the human.” The autocomplete idea, in particular, directly influenced the TransType project, the first interactive statistical MT system. A conspicuous lack in the published record of interactive MT research since the 1980s is reference to the HCl literature. The Psychology of Human-Computer Interaction, by Stu Card, Thomas Moran, and Allen Newell, was also published that year. It is now recognized as a seminal work in the field which did much to popularize the term HCl. In retrospect, the connection between interactive MT and early HCl research is obvious. Kay, Melby, and Church had all conceived of interactive MT as a text editor augmented with bilingual functions. Card et al. identified text editing as “a natural starting point in the study of human-computer interaction,” and much of their book treats text editing as an HCl case study. Text editing is a “paradigmatic example” of HCl for several reasons: (1) the interaction is rapid; (2) the interaction becomes an unconscious extension of the user; (3) text editors are probably the most heavily used computer programs; and (4) text editors are representative of other interactive systems. A user-centered approach to translation would start with text entry and seek careful bilingual interventions, increasing the level of support through user evaluation, just as Bar-Hillel and Kay suggested many decades ago.

Recent Breakthroughs in Interactive Machine Translation. All this is not to say that fruitful collaboration is absent at the intersection of AI and HCl. The landmark work of Horvitz and colleagues at Microsoft established mixed-initiative design principles that have been widely applied. Bar-Hillel identified the need to find the “region of optimality” between human and machine; Horvitz's principles provide design guidance (distilled from research experiences) for finding that region. New insights are appearing at major human/machine conferences such as UbiComp and HCOMP. And the explosion of data generated by companies has inspired tools such as Tableau and Trifacta, which intelligently assist users in aggregating and visualizing large datasets.

However, language applications have largely escaped notice until recently. Post-editing has had a mixed experimental record. Some studies found that it increased translator productivity, while others showed the classic negative results. At CHI 2013, we presented a user study on post-editing of MT output for three different language pairs (English to Arabic, French, and German). The between-subjects design was common to HCl research yet rare in NLP, and included statistical analysis of time and quality that controlled for post-editor variability.
The results showed that post-editing conclusively reduced translation time and increased quality for expert translators. The result may owe to controlling sources of confound overlooked in previous work, but it may also come from the rapid improvement of statistical MT, which should cause users to revisit their assumptions. For example, to avoid bias, subjects were not told that the suggestions came from Google Translate. These quantitative successes contrast with the qualitative assessment of post-editing observed in many studies: that it is a “boring and tedious chore”. Human translators tend not to enjoy correcting sometimes fatally flawed MT output. In the previous section we showed that richer interactive modes have been built and evaluated, but none improved translation time or quality relative to post-editing, a mode considered as long ago as the 1962 Georgetown experiment.

Overall, this recent successful inclusion of user input with functional machine learning has made great strides in providing faster and more reliable translations, also minimizing the exacerbated “telephone” effect of translating one message into another language, then a response from that language back into the initial language which has historically seen smaller errors compounded the more these back and forth translations have been completed.

And some of the language translation engines mentioned, including Google Translate, are seen as reliable backbones for general translation, most recently for longer text strings, such as several sentences in a row, yet without major grammatical errors. While there is a high rate of compounded errors from dual-translation (e.g. when a user translates a short piece of communication from their preferred or only language into another language to send to a friend who speaks that language) the errors for shorter length messages are minimal.

But when a response is sent back after being translated, often distortion effects on intended meanings from originator/sender increase.

Of course there are other meaning vehicles in communication outside of words themselves. How a message is delivered—which is through non-verbal body language (and is outside the scope of our discussion for purposes of this application), and tone and pace of a sender's vocalized communication. In addition, there are additional benefits to real-time conversation that even rapid correspondence cannot provide. With that in mind, we will briefly topline the currently accepted components of communication via modern linguistics theory, and then discuss conversational theory, premised on leading semiotic scientists

Gordon Task's 30 year focus in this area, and then on message meaning and vocalized encoded meaning.

Human speech, or vocalized language, is the vocalized form of communication used by humans, which is based upon the syntactic combination of items drawn from the lexicon. Each spoken word is created out of the phonetic combination of a limited set of vowel and consonant speech sound units (phonemes). These vocabularies, the syntax that structures them, and their sets of speech sound units differ, creating many thousands of different, and mutually unintelligible, human languages. The vocal abilities that enable humans to produce speech also enable them to sing.

Speech is researched in terms of the speech production and speech perception of the sounds used in vocal language. Other research topics concern speech repetition, the ability to map heard spoken words into the vocalizations needed to recreate them, which plays a key role in vocabulary expansion in children and speech errors. Several academic disciplines study these; including acoustics, psychology, speech pathology, linguistics, cognitive science, communication studies, otolaryngology and computer science. Another area of research is how the human brain in its different areas such as the Broca's area and Wernicke's area underlies speech.

It is controversial how far human speech is unique; in that animals also communicate with vocalizations. While none in the wild have comparably large vocabularies, research upon the nonverbal abilities of language trained apes such as Washoe and Kanzi raises the possibility that they might have these capabilities. The evolutionary origins of speech are unknown and subject to much debate and speculation.

Speech production is a multi-step process by which thoughts are generated into spoken utterances. Production involves the selection of appropriate words and the appropriate form of those words from the lexicon and morphology, and the organization of those words through the syntax. Then, the phonetic properties of the words are retrieved and the sentence is uttered through the articulations associated with those phonetic properties.

In linguistics (articulatory phonetics), articulation refers to how the tongue, lips, jaw, vocal cords, and other speech organs used to produce sounds are used to make sounds. Speech sounds are categorized by manner of articulation and place of articulation. Place of articulation refers to where the airstream in the mouth is constricted. Manner of articulation refers to the manner in which the speech organs interact, such as how closely the air is restricted, what form of airstream is used (e.g. pulmonic, implosive, ejectives, and clicks), whether or not the vocal cords are vibrating, and whether the nasal cavity is opened to the airstream. The concept is primarily used for the production of consonants, but can be used for vowels in qualities such as voicing and nasalization. For any place of articulation, there may be several manners of articulation, and therefore several homorganic consonants.

Normal human speech is pulmonic, produced with pressure from the lungs, which creates phonation in the glottis in the larynx, which is then modified by the vocal tract and mouth into different vowels and consonants.

However humans can pronounce words without the use of the lungs and glottis in laryngeal speech, of which there are three types: esophageal speech, pharyngeal speech and buccal speech (better known as Donald Duck talk).

Common Issue with Existing Web-to-Wireless Voice Translation: Privacy Apart from the other technical limitations described there is a common, though less discussed, danger with voice to voice translation delivery, through third parties or third party translation engines, such as Google Translate, which many are premised upon. As Emanuel Weisgras, Esq. (CEO of Weis Words International Translations and lawyer) was recently quoted in “Why Machine Translation Can Be Truly Dangerous”, “If you are an attorney, when you offer text to a translation site, you could be in violation of your legal and ethical obligations to keep your client's information confidential. If you are a business, you are placing the sanctity of your intellectual property and trade secrets at risk. How can this be?! All you did was use a simple online tool, right? How could things go so wrong? The answer is in the fine print. In Google's Terms of Service for example, which apply to services including Google Translate”, it states, “When you upload, submit, store, send or receive content . . . you give Google (and those we work with) a worldwide license to use, host, store, reproduce . . . communicate, publish . . . and distribute such content.” How is that for a kick in the butt? Plus, if you are on an unsecured wireless (Wi-Fi) network such as those offered in many cafés, libraries, and similar institutions, you run the added risk that the content you send to your preferred machine translation provider will be intercepted by unscrupulous hackers.”

Primary Channels for Machine Translated Human Language. The largest (by use) channel for text and even voice (speech) translation is via web-based communication interfaces are currently used for individuals who speak the same and different languages, between distances of miles or continents. To communicate, the two individuals speaking different languages natively can utilize translation software. These existing technologies, however, are inflexible and are restricted to only one language translation application programming interface (API), primarily to one-way decoding (e.g. into text), due to limitations in processing speed and technology. This is not ideal, since APIs are better at translating specific common languages, and are inferior at translating others.

Utilizing the present technologies thus results in suboptimal translation accuracy. In addition, current translation technologies typically use a single mode of communication (e.g., chat, email, or short message service (SMS), and if voice language, in one direction from language A into language B, so that the recipient must receive a voice translation translated into text, due to limitations in processing speed and machine learning capabilities from current technologies. [0056] Speech or vocal communication requires significantly higher data rates than text-based data due to the higher bit rates for sound waves versus text characters. Therefore, current vocal communication translation interfaces are limited to non-conversational speed, and without machine learning components, limited to a handful of combination languages between individuals, such as English and Spanish. None utilize machine learning algorithms to expand beyond pre-existing databases to learn new language or words or dialects in the process of translating live communication.

Currently available systems typically do not allow for users to communicate across multiple platforms. In addition, all current technologies are limited to individual languages with limited languages and even more limited vocal encoding decoding, and none with higher-level semiotic engines, such as our invention, that allows human users to even use gestural languages as input and output, such as sign language, nor any go beyond human languages, such as ours which can go from visual symbolic languages, such as sign language, to even advanced animal languages or machine languages.

There are some nascent speech translation services for mobile phones, and a few for smartphones (which essentially are other web-based translators that use input from a user's mobile phone via speaker, run the translation through a web based service, for example, Google translate, and then back through their application to a second party.

While most of the development focus in recent years has been dedicated in smartphone application development, the core technology for delivering voice itself wirelessly, potentially across the globe is already astounding.

Especially when considering the amount of data that is converted and transmitted for audio versus text. This is also, why voice translation for wireless use is still so limited, as batch processing (as the current standard) significant blocks of audio data sent wirelessly for translation and then spread out off-device servers and then repackaging and sending that back through wireless channels is significantly more challenging than direct web translation, such as with the current leader Google Translate, already limited to 60 seconds of audio and text-only output!

To provide further example of “not all data is the same”, and to demonstrate the difference in sheer size of text versus audio data, we've provided the following table to illustrate the difference between message data between formats. For this example, we use a fixed standard of a 5 minute conversation between two individuals to compare data rates across mediums. With standard formatting, a typical page contains 500 words, but for the purposes of comparison, we will use “1 page” for comparison. The following table shows standard sizes for symbolic information encoded into different formats, from text, image, voice, to video.

While there are a number of pre-existing technologies that can rapidly translate text from one language to another, even those technologies have yet to be commercialized due to processing constraints, either when through personal computer (PC) to PC over a network via a server at standard data transmission rates, or even in the more challenging environment of processing and transmitting between two smartphones.

Nextweb.com's ABHIMANYU GHOSHAL, on Jan. 11, 2015, wrote: “Google will announce the updates soon [to its Google translate service], to make it easier for language learners, travelers and businesses to communicate more easily . . . with foreign language speakers. The New York Times also says that Google will launch a service to automatically translate foreign text into your native language on your smartphone, simply by pointing your device's camera at, say, and a street sign.”

While this is technically voice translation to text, or text to text via OCR, and not voice to voice, Google is certainly the leader in language database compilation and literal translation engine. Still, the general focus is on translating pieces of communication, and not enabling interactive conversation. The limitation is not based on the specific words in the databases among different languages, or the speed of the actual translation, which even for Google, for a complete sentence is only a matter of seconds, but in that all current voice or text systems or devices are based on batch processing and single linear system processing, from point A to point B, akin to swapping notes between two people, albeit translated, not organic productive conversation, or the benefits of that. [0068] But the gold standard is still Google Voice Translate, which, while capped at 60 seconds of speech (voice data), and still only speech to text in its translation, has been proven to be both accurate (+/−10%) across dozens of languages, though with no capacity for dialects, which is the provenance of systems with adaptive AI, or machine learning. However, as the gold standard, while the actual processing is in megabytes (and not kilobytes, such as with text), the home-advantage for Google is of course its own massive distributed computing power for this type of processing. This is because it's not just processing high-data rate sound and converting into text, it's also coordinating meanings between languages and massive databases incredibly quickly. It is why it is also a good example to show its fatal limitation, from the perspective of conversational language speed, in that it, too, based on “efficiency” in processing from a machine or computer perspective is in batch processing. That is, for the one minute of speech, a user 1 must record the speech, then have it translated as one collection of data, and then as translated text, be processed (mentally) by the receiver, based on their own reading speed and speed of reading comprehension, this adds another few minutes of human processing around this single message. It is not about: slow translation”, Google's capabilities in speed of translation are unparalleled, in fact its core translation engine is the engine used by much of the prior art we will discuss. The limitation as far as interactive dialogue purposes is the general translation process and model itself, with batch processing. This is important, as the length of voice translation, in this case, with Google Voice to text, is longer than what is necessary for standard conversational contribution, that is, for conversations to be interactive and productive (additive vs argumentative around individual's points and agendas), each contribution should consist of one core point, idea, or model, typically, on average contained in a few sentences, but from a written content framework, a single paragraph. This can typically be achieved, depending on the depth of meaning in the content being conversed, in 20-30 seconds, and overloading points or ideas in one individual's contribution to a conversation makes it difficult for a second member of a conversation to respond directly, as multiple points have multiple potential responses.

On the other hand, the limitations of voice translation devices are in processing and length, as well as ambient noise based on capture methods for a physical hand-held device that makes it difficult for parceled communication between two people in public, and impossible for an actual interactive 2 way conversation. Even with off-device translation language database access, handheld devices simply do not have the capacity in memory and processing to either a) translate enough speech to match a fully formed conversational point before even b) allowing for 2 way, double language double database access for two way vocal conversation. Though none claim that regardless. The claim of “voice to voice” is human user (inputting words) to machine translated machine voice. And in the following citation of prior art that claims “real-time” translation, the translation itself is limited to a short phrase, though in real world testing sadly has difficulty in translating even a few words. But again, the major limitation in the most advanced handheld voice to voice translator is that for it to be handheld and used in front of another person for communication, it—unless those 2 people are in a closet, and not two strangers in public—the form factor of the device—including an external microphone to pick up the primary user's voice is the problem in that necessitates a public space and ambient sound pick-up, thus the introduction of noise into the channel, which to a translation engine is simply more audio data.

Before reviewing prior art that is premised on these various technologies or sciences (excepting conversational science, or course), we will discuss, in brief, machine learning, as it is a key field and area of development that has helped further capabilities of machine translation, specifically around introducing new dialects into machine dictionaries for translation and thus enhanced accuracy in translating between different geographical areas beyond adding core languages.

Machine Learning is a field of computer science that gives computers the ability to learn without being explicitly programmed. Machine learning evolved from the study of pattern recognition and computational learning theory in artificial intelligence. Machine learning explores the study and construction of algorithms that can learn from and make predictions on data—such algorithms overcome following strictly static program instructions by making data driven predictions or decisions, through building a model from sample inputs. Machine learning is employed in a range of computing tasks where designing and programming explicit algorithms is infeasible; example applications include spam filtering, detection of network intruders or malicious insiders working towards a data breach, optical character recognition (OCR), search engines and computer vision. Machine learning is closely related to (and often overlaps with) computational statistics, which also focuses in prediction-making through the use of computers. It has strong ties to mathematical optimization, which delivers methods, theory and application domains to the field. Machine learning is sometimes conflated with data mining, where the latter subfield focuses more on exploratory data analysis and is known as unsupervised learning. Machine learning can also be unsupervised and be used to learn and establish baseline behavioral profiles for various entities and then used to find meaningful anomalies. Within the field of data analytics, machine learning is a method used to devise complex models and algorithms that lend themselves to prediction; in commercial use, this is known as predictive analytics. These analytical models allow researchers, data scientists, engineers, and analysts to produce reliable, repeatable decisions and results and uncover hidden insights through learning from historical relationships and trends in the data.

There are several recent human-computer interface based machine translation for human language translation methods proposed, for example, in the U.S. Pat. Nos. 9,195,652 (2005), 9,507,774 (2016), 8,868,430 (2014), 9,600,474 (2017), 5,987,401 (1999), 9,235,567 (2016), 9,298,701 (2016), AND 9,514,377 (2016).

The general focus for this group of prior art is on literal language (machine) translation speed and accuracy, for example aggregating multiple language database programs for broader choice of translation or larger breadth of options to better convey meaning from one communication set, or ways of seamlessly integrating multiple languages outside of the most developed language translation databases of engines (such as French or English), but all still premised on parceled communication, not conversation (direct interaction, conversational speed of information and meaning being shared), in other words, the communication format itself between two individual's whose source languages are different, but rather solely on the accuracy or breadth of information for language translation engines literal word being translated.

Nevertheless, all of these language translation methods, systems, or programs focus on improvements in how languages are translated, to improve accuracy of meaning conveyed from one language to another, or using multiple languages in one system, whereas none are novel in how one user or two users communicate through translated languages with one another. They are predicated on the same (non-conversational) translated communication system of input in one language, translation, output in another language, then receiver having to understand the meaning embedded in the original language input before formulating a response to that meaning and going through the exact same process to respond.

As a whole, the prior art cited has a few shared limitations.

All are limited to either one way translation from one language to another via voice to text or text to text translation, or two way text to text translations between two languages, none capable of two-way, bi-directional language translation using voice to voice
All are either predicated on other pre-existing language translation software, such as Google, or aggregating several open source translation engines, and still all include additional steps of communication versus a standard back-and-forth conversational communication. In other words, the communication “signal” is always staggered through a process of input, translation into another language, output in text in this second language, time for receiver to then interpret the actual meaning of the originating message before being translated, and thus there is still an extended gap in actual communication that does not allow for conversational flow and evolution of a conversation versus parsed communication.
None use methods or devices specifically for mobile computer to mobile computer use for both processing and direct voice input and output from both individuals to facilitate a true real-time, adaptive conversation.
In addition, the prior art that does use the descriptive phrase “real time” is specific to rapid translation and is predicated on the same translation engines as many of the other systems cited in prior art (for example, Google Translate), and this, specifically, refers to high-speed translation from an encoded (e.g. text) message from one language to another. This prior art specifically does not cover real-time communication, that is, the encoded transfer and reception (in vocal message) of the message by a receiver, nor real-time comprehension and response encoding from this second User. Forexample, in U.S. Pat. No. 9,600,474 to Cuthbert, titled “USER INTERFACE FOR REALTIME LANGUAGE TRANSLATION” describes a device that accepts voice or text input and displays translated text on a screen. While this is relatively “fast” it is not truly real-time because the entire text or voice message has to be encoded and submitted before translation, and Google translate, independently, can in a few seconds translate from one language to another on a user's chosen screen. In addition, text on screen must still be read by a receiver and then processed semantically for understanding, voice receipt of information can be decoded while it is being received, though that meaning of “real-time” is less in literal translation and more specifically in conversational speed processing of a message in real-time, or near real-time.

An example of a recently released existing voice translation device, and the one in-market voice translation device that claims “real-time” translation, but is still premised and limited to batch processing is a Japanese-made device named “ili”, produced by the Japanese company Logbar.

Apart from the company admitted limitation of capacity to translate at most “a phrase” of vocalized words, though in practice, demoed at one or two words alone, Journalist Nadia Agrawal, recently made the limitation for a free standing voice translator to be used between two individuals is . . .

“It looks like a USB flash drive, hangs around your neck and works without an Internet or cellular connection. Despite sounding pretty cool, ili has had some very odd promotion. In one ad by Logbar, the company behind the device, a foreigner in Japan uses ili to ask women he's never met before to kiss him. The video includes several scenes of the spokesman getting shut down and even shoved by offended women . . . The gadget pulls from a database of words and phrases for its translations and can currently translate between English, Chinese and Japanese. Ili premiered this week at the International Consumer Electronics Show in Las Vegas, but curious attendees weren't able to see a proper demonstration of the device's abilities because of the noise on the show floor.10”

While the press responded to the device as “horrible”, the literal translation from one language to the other, when in a quiet private location without noise (e.g. in public, in a crowded street), does work. However, as it is premised on a single system and process and thus from one language to another, it is also limited to translating from one language to another, without consideration for the receiver to respond in their language back to the user/original speaker. In addition, it is also limited, as is any prior art in voice translation to batch processing, that is, processing whole what a user says after they have spoken, and limited to a phrase length comment, though in practice, it had difficulty with individual words in speech. Thus it cannot serve as an interactive conversational tool, and is still premised on the old paradigm of individual whole messages “sent” from Sender to Receiver.

Voice translation itself is not new, two multi-billion companies, including Microsoft (Skype) and Google, have been heavily focused on development in this area since 2010. And, many of the translation devices and systems previously mentioned use Google translate as their primary translation engine!

The issue with these devices for face-to-face translation is twofold. First, a user's voice is transmitted from a distance to the device microphone, but as its output speaker is also on the device, it is exposed to ambient noise from soundwaves from the general vicinity of the user as its use is public, to play the translation to another person. This is a physical issue with voice translators for face-to-face communication. And as the device does not have machine learning capabilities (a limitation of this cited prior art specifically, but also for storage and processing capacity for true AI learning capacity program itself), it cannot also learn the user's voice over time to store a referenceable profile with the specific characteristics unique to that user as to separate ambient “noise” at input from that voice input.

Second, the actual translation, while cited as “real-time” is the same as other prior art, in that while the voice translation engine is fast, it is batch processed, so that it is not translated until after the user/speaker 1 has completed their communication. This is also why it is shown as translating individual words. This is a core limitation for all language translation devices or systems for all prior art, which relies on batch processing, thus enabling communication snippets, analogous to back and forth messages, but not enabling actual interactive conversation.

Regarding more recent prior art, some work as aggregators, simply using multiple pre-existing translation programs that are open source, to translate from one language to another, second language, but without even considering the “receiver” of the translated message as also a “sender” in response, such as U.S. Pat. No. 9,195,652 to Custer, et al. (2005) While using multiple engines means this prior art is essentially an aggregator, reduces the normal error rates from machine translation in general, this is still another text to text based translation program, with several actual translation programs brought together to translate a message from one person to another, and allowing the “receiver” to choose from translations, without even knowing the true originating message to decide which translation is “best”.

Quite simply, sending blocks of translated text or voice to text back and forth is becoming more and more common, but this does not afford the “recursive interaction” (Pask) of an actual conversation, where topics or concepts can blend, morph or change based on the direct response thinking and feeling that a conversation enables. With current available technologies, even the most advanced that can rapidly decode, translate from one language to another, and even one mode to another, such as voice to text, there is not a 2 way interactive conversation, but rather two individual's clarifying their individual points typically to determine one shared action or agreement based on time commitment. For example, translating a voice from one language into another language and outputting as text, even just one sentence, still takes several seconds (dependent on complexity of language and content), but also then requires additional time for the “receiver” to process the information once delivered, such as reading and thinking about the content of the text received. This length is increased based on how much data is being conveyed, the more data, the more time a receiver has to process before responding, and also the likelihood that additional responses are required based on additional data sets conveyed from a “sender”. With this in mind, transmitting a translated sentence, receiving it translated and processing its meaning, forming another response sentence, translating that, receiving that sentence, and processing it, may take up to a minute based on current technological limits, even though the actual translation time may only take 5 seconds (×2). Whereas a standard two-way conversation contains 130 words per minute, and the structure and output of the conversation can change several times in that period itself, as there is no need for communicating secondary or tertiary support information for initial points that are determined consensually irrelevant to the ultimate or modified goal of the conversation.

To better illustrate the limitations of all current voice translation systems and their inability to enable a gapless and thus direct and fluid conversation between two individuals, and that the major component of this limitation is in the current model for machine translation of human speech itself, we'll use a similar (structure) and labeled diagram as we did for showing Pask's examples of unique concept building structures from a conversation versus parceled messaging communication:

Using the “extreme” case of Google Voice, at 60 seconds of voice (speech) recording and thus batch translation capacity as maximum amount for processing capability is unnecessary, since fluid conversations require each participant to contribute no more than one core concept or response to a concept or topic at a time, which is typically, on average 30 words per conversational contribution, but we'll still use the extreme case to show current machine translation technology and prior art at its highest level of performance, even assuming the fastest mode of message delivery-voice, even though the most powerful in market voice translation system is Google which is limited to text output for d livery to another individual. This “ideal” combination of various machine translation in-market products and prior art claims would look like this: [0091] Using “T” as topic or concept, such as in Pask's examples of conversation structure, in the current linear delivery system of one way voice translated message, a 60 second translated message would take over 2 minutes in total to convey and receive, even assuming only 1-3 seconds for the actual format conversion and translation component of the “translation”. We have used an “approximately” 1-3 seconds as even though Google Voice consistently—with accuracy+/−10% from testing—translates an entire minute of voice to another language (in text) in an average of 2 seconds (from receipt of the entire recording), U.S. Pat. No. 9,600,474 to Cuthbert, cites in its title and claims “real-time translation”, which would suggest “faster” than the in-market gold standard Google Voice for translation, thus “1 second”.

Due to the gaps in current translation technology that exist based on the current and accepted “common” structure of machine translation for human natural language itself, such as the added time to receive and hear a new audio signal in the translated language for comprehension, without even taking into account either longer (human mental) processing time for multi-part message meanings, such as with a 130 word, 60 second voice message, these systems have been shown as unidirectional, from sender to recipient. However, we have added one response, so show the total time for a basic statement and response (which would be a logical next step in further development of a system that starts based on two different in-put and output languages between two individuals to minimize set-up time). This would show a topic being sent and translated T1, and based on the format and limitations, instead of a T2 (as new topic being introduced from a second user), T1b given the need to respond before adding in a linear communication system like this. Nevertheless, as the receipt gap of T1 (having to listen to a second audio stream before processing it), we've added a 10 second response formulation period, which assumes either a topic in T1 User 2, the receiver already has some familiarity with to formulate a quick response. We also have used approximates for translated audio length (in words), as depending on specific language, it may require less or more words to convey the same topic. Nevertheless, using the fastest and highest capacity in-market and theoretical components from prior art citations available, currently, a “call-and-response” message with dual translation, batch processed as is the norm, would take approximately 4 minutes. What is not captured is the additional ideas and thoughts that individual's come up with from conversational associations that drop quickly from short term memory when there are transfer time lags and gaps such as in these current communication systems.

While we have endeavored to show “best current case” through using the most advanced pieces, such as the fastest known voice (to text) translation system combined with a separate claim of voice to voice translation, and another of “real time” translation, we are not able to cite any one system or product that can even do all this in 4 minutes. But to be thorough, if including all limitations for individual systems, if replacing translated speech delivered as speech with text, while it would reduce the “receipt time” for the receiver, in that a person can see 130 words as text (in whole) faster than having to listen to voice audio from beginning to end, the user would have the added time of having to read 130 words of text. Assuming this reading time does not exceed significantly the listening to comprehension time of audio data by a receiver, we have used voice to voice in this example for simplicity to determine and average baseline (of 4 minutes for translation, receipt, comprehension and response, translation, receipt of response, and comprehension between two people based on the current general limitations of machine translation as demonstrated by the fastest/best systems in prior art citations or current voice translation products in market. [0094] While Google Translation engine is often referred to as the most advanced translation engine with the greatest variety of words and options for meaning and accuracy, its own voice translation program is limited to voice to text translation. However, for communication, the advantage of its 60 seconds of speech recording allows for longer than conversational contribution meaning, as this, at over 100 words in text to be sent to another would take at least a minute of human processing after receiving translated in speech.

With voice to voice translation, due to the significant higher bitrate for voice data (show), while online processed applications, such as Google voice translate can utilize massive distributed computing power of Google to translate up to a minute (or) of multiple users, for handheld devices, the processing power is limited, even when sent off device. The maximum length of words translated in voice to voice in a freestanding and device embodied system from testing is currently approximately 5 words, which is a small sentence. In conversation, while it is unproductive for one member to speak for a minute as it requires the recipient to hold meaning content for that, essentially a full paragraph in their head while proceeding addition information, certainly there is a minimum length to convey complete meaning of a thought, idea, or point, which is certainly longer than the handful of words these translators can translate at one time. However, this is due to the paradigm itself of batch processing text or audio (speech) content for translation in itself.

Regardless, no prior art demonstrates the ability to achieve dual-language, bi-directional voice to voice translation that could enable an actual conversation. While we have shown the limitations in current technology, are not in the literal aspect of translating text or voice itself, but rather even “real-time” voice translation in how the paradigm of machine translation itself is limited to batch processing, which is ideal for optimal machine language processing (amount and speed), it is specifically, not the right structure for conversational communication for human language itself.

Unfortunately, one ideal usage of voice translation systems is for voice to voice conversational conversation, which also required bi-directional two way translation through a single system for two people speaking different languages to converse. Thus, there is a need for a new systems and method of machine translation itself to provide cross-lingual communication without requiring linguistic or technical knowledge or expertise, but to allow for gapless speaking and translation and response. Currently, there is no machine translation system, method or technology that enables a two-way conversation—at the baseline rate of words-per-minute or fluidity of topic shift which also requires immediate speech receipt for rapid semantic processing by receiver-between two individuals speaking different languages.

### SUMMARY OF INVENTION

In view of the limitations now present in the prior art, the present invention provides a new and useful means of using machine translation for human speech that processes, translates, converts and transmits individual monemes or words as they are being spoken by one User as an audio stream through an audio channel 1, and delivers the translated words or monemes as audio in sequence so they are assembled in order and to the receiver as one audio stream over audio in their language, and so that the receiver, User 2, has already heard and (mentally) processed the meaning of the sender's message as they are delivering it in their language via audio channel 2, and can respond immediately to User 1 through the same system, and continuously back and forth as a real time conversation even though the two individuals speak two different languages. Other advantages are described in more detail in the following section.

### Advantages

For language translation applications that facilitate interactions between two users speaking different languages, the input and output for voice recognition and spoken translations may overlap, be interrupted, or need to be sequenced to meet user needs. Thus, a challenge with voice input and spoken translations is that there may be multiple modes, steps, delays, failure points, and situations where the user can take an action or set preferences that control behavior of the sequence of interactions. More importantly, language translation applications, including speech to speech translation, which has up to 100× the data rate versus text to text translation, are premised on the core assumption of scale processing, where groups of words are batch processed together for fastest overall translation speed. However, as that model is most efficient for most types of computer or machine data conversion, it is specifically not conducive to a human to human conversational communication model, where two or more individuals can respond directly and spontaneously to each other's contribution to a conversation, with either a social or knowledge building goal, as even the “fastest” translation systems, such as Google translate—which use data-batched processing, double the length of actual communication from a content perspective, first waiting for a User 1 to complete their text or speech, processing (quickly), then outputting in a second language, which for a second User requires the same amount, or approximately the same amount, to receive and then process the information User 1 inputted in a different language. At best, this is “faster” messaging but with doubling the communication sending time, certainly not gapless, interactive conversation, not could ever be based on the core processing model used.

Advantageously for the purposes of conversational communication between two individuals, our system and method recognizes, converts, translates and outputs each word as a user is speaking it, using parallel processing to intake and process one word while the prior spoken one is already being output as machine speech in a second language, and so on until the first User speaking into our system has stopped talking, at which point the translated speech has already been delivered (technically, the last word of translated speech in approximately under 1 second after the last word from User 1 has gone through our system). Of course, referring to Google Translate and its use in speech translation applications, which refer to themselves as “real time” translation, with an average capacity of 30 words at a time, is fast. Consider however, that a person speaking into that—or a current art speech recognition and translation system, system speaks (at an approximately slightly slower rate than 60 words per minute, based on reports on the recognition speed of the related systems, which is the low end of normal conversational rate) for approximately 30 seconds, the translation itself once received, may only take a few seconds, but then the output, if in speech in another language would take an additional 30 seconds, and a “receiver” or User 2, would not be able to formulate a response to that information until they've received the translation in their language. In other words, 30 words in speech even translated “immediately” or in “real time”, takes a full minute to “send” to another person at the fastest of any of these “real time” translation systems. Our system does not claim to be faster in literally translating, total end-to-end time is still constrained by the speed at which a user speaks, but as ours continually but individually receives, converts, translates and delivers each word as it is being spoken, and the per-word translation time is still in milliseconds, and not seconds, and as our system uses 2 audio channels so one person can be speaking in one language while our system's machine speech of their translated message is being outputted without “cross-channel” noise, even if a person chooses to speak more slowly than normal, such as with prior art systems dependent on voice recognition, the total duration for a 30 second speech with translated speech output is approximately 31 seconds. And, just as importantly, a “receiver” can respond immediately so the original “sender” in a conversation does not have to wait for second language output either. However, another advantage in this 1-to-1 Just in Time word by word processing (which as it is a previously non-existent method of processing large amount of information, we've named it “single unit mass production and assembly”, is that there is minimal concern for processing capacity, such as Google's own 30 word limit, which reduces all other component drag, such as speech recognition and machine speech output, so that a user can speak at normal conversational speed. This is why we cite approximately 30 words from one person to another and one language in approximately 11-12 seconds.

The other benefit of parallel processing for sequential in-process input and output for separate words in a spoken series is in reassembly. That is, the machine speech output can be reassembled, through use of a bridge processor to bring in 2 data streams concurrently, and reassemble as a stream in the order they came in, and at the same speed (or even slightly faster to directly match overall input time) so that outgoing machine speech will be paced in the second language at conversational speed, as a stream of words for cogency and ease of receipt and (mental) processing.

In addition, systems and methods for speech-language translation are linear processes, and not a looped system for continual conversation. That is, one User inputs speech, it is translated by the system, then converted to primarily text in another language, then (mentally) processed by a second user before they can formulate a response. But User 1 first has to open up or activate the system and select a receiver and the receiver, User 2, has to open up another instance of the specific system after being notified of User 1's desire to communicate with them. To respond, they do it through their own separate usage of the same system. In part this is because prior systems are typically focused on individual parts of translation, Google in the literal text-to-text language translation, while telco carriers are responsible for the front end piece of speech capture, recognition and delivery to the traditional language translation program, which as we've shown in several cases in the prior art section is Google translate, which is open source and openly available for commercial use. This daisy-chained system leverages the resources of other companies to deliver a consumer-worthy service. However, this prevents the ability for storing one set of user data across the entire path, and being able to model it for machine learning in the long term, and also requires multiple users to integrate different pieces of a translation system every time they use it. This integration is not difficult, but it is why there is no true single speech recognition, language translation, machine speech output and delivery system that enables true conversations between individual users over time as they are in the same single system.

This is also why our system and method, over time, can easily gather and organically pattern user data to model even its machine speech on User speech patterns organically, based on its native system and method of speech recognition and data basing at point of translation which is already connected as a process to machine speech output. This capability is inherent to our system based on its uniqueness and not a separate machine or functional build.

### DETAILED DESCRIPTION OF INVENTION

In response to these and other needs, the present disclosure provides a novel machine translation system and method which captures active speech of one. User and translates and delivers each individual and sequential moneme or word as a larger sentence or message is being spoken, delivering each moneme or word translated and converted through our system's machine generated speech to a second user (receiver 1) moneme by moneme or word by word throughout a second individual via machine speech in their own language so that when a person (user 1/sender 1) is finishing their speaking, a user 2 (receiver 1) has already received user 1's message but also processed in mentally having received it as an audio signal in their (user 2's) language and so they can respond directly, without pause just as in a typical face to face single language conversation/dialogue and so User 2 becomes sender 2 and speaks their response directly, our system translates this speech as it is being spoken into User 1's language and delivers it through audio channel 2 to User 1 while User 2 is still speaking their response, so that User 1 has already mentally processed the content of User 2's response at the same time User 2 is completing their verbal response to User 1, so that there is no gap in communication, which is expressly why our system and method uniquely enables interactive, direct-response conversation, versus translated communication (or a dialogue versus two monologues) between two individuals speaking different languages.

In addition, as it is an enclosed system, that is, instead of being a (as current technology) linear speech translation and translated speech to receiver single process based system; it is uniquely a parallel processed ongoing translation and delivery system for two individual users. This is to say, sender and recipient in a typical machine translation system for natural language processing, in our system also become sender and receiver so that it is completely enclosed in its own circumscribed loop. In other words, User 1, Speaker 1, Sender 1, also become Receiver 2, and User 2, Receiver 2, also as Responder 1, become Speaker 2, and Sender 2, and so on in a continual loop until a conversation has been completed, or by both participants agreed is complete for the time they have allotted, it is a system in which the information being exchanged or shared, if signals are being delivered through a wireless or wired system, can be encrypted automatically as part of that system's native processes. That is, as the signals can be automatically decrypted within the enclosed system so that both users can have unmitigated access to the content of each other's thoughts conveyed in speech, but any member not within the system cannot breach it as the system itself is encrypted and has its own decryption logic.

As the audio input starts from speech initiation at either user point, our system's speech diarization program and processor receives and partitions the input audio stream into word root (moneme) segments and sends each translated moneme or word or words (dependent on the idiosyncratic meaning embodiment of different languages) as it is being received, that is while the first speaker is still speaking, the process is really two processes, as speech as analogue audio comes in as a stream, but from a bridge processor, is parceled out one word at a time, so that moneme or word one is converted to text in Processor 1, Translated via the language database into other language text in Processor 2, Converted from digital text to analogue audio in Processor 3, and transmitted from (machine) Transmitter 1 to Recipient 1 (User 2's) machine receiver 1, though processing to machine speaker for audio output and User 2's hearing, WHILE moneme or word 2 is being processed from Bridge Processor 1 to Processor 4, and 5 and then through Transmitter 1 to then be received by Recipient 1 (User 2) and the heretofore listed process to hear translated moneme or word by User 2 immediately after moneme or word 1, and so on, until User 1, Speaker 1 has completed their message (manually set by Users by length of pause, into the system, such as 2 seconds, which is 2 times the length of an organic human pause between sentences), so that if User 1 speaks 30 words in 30 seconds, User 2 has already heard their message as translated into their own language, with a normal system gap of about 0.5 seconds between the last word spoken by User 1 in message 1, and the last word heard by User 2 in translated message 1, so that User 2 has already processed the linguistic meaning of User 1's import as they have completed speaking, and thus can respond conversationally, aka directly, to User 1 upon their completion of message 1, without any break as is common to all current technological machine language translation systems.

Further defining “break” in this context, a “break” would be the current machine language system gap in communication, that is, the 30 seconds to receive a message as it is spoken (using a 30 second message to match the above example), assuming minimal actual translation time of that speech (>1 second), and the normal time for a translated message to be heard and processed by a receiver after it has been sent or spoken by the machine, which in this case would be another 30 seconds. This “break” then, which our system eliminates, would be approximately 1 minute.

In addition, should a User of our system desire to add a meaningful pause, or break to reformulate part of their thought, they simply say “Pause” which the system recognizes as a media-res pause, and that is communicated as “Pause” to the Receiver and the message flow continues as soon as the User 1 begins to speak again.

Of course, as our system and method includes two users in the system, that is to say uniquely both sender and receiver, as opposed to current linear single process systems, with gapless translated content, User 2 becomes Sender 2 when responding to User 1's initial message, so that our system's heretofore described processes are repeated for User's 2's response message to User 1. And then these processes are again repeated for User 1 when they become a respondent to User 2's response. And so forth until a conversation has been completed per participant's initial knowledge creation goal, or deemed complete by both participants due to an agreed upon time limit.

As out system is a novel machine language translation system, one that naturally componentizes parts of an active message while being input, this creates an additional benefit of more detailed and simpler analysis of part of that signal. So, the machine learning component of our system focuses on the non-linguistic aspects of the communication signal, versus the general focus of machine learning in machine translation on linguistical deviations or additions for, as a main example, learning new dialects of core languages to better or more accurately translate with accuracy these idiosyncrasies. Our system's machine learning focuses on learning the unique characteristics of its repeat User's own vocal imprint. That is, by recording an analyzing individual vocal data points on tone and frequency, enabled by the system's natural atomic partitioning of individual monemes or words for ongoing translation and delivery, it also is set up to record and organize a database of that individual's unique vocal characteristics more precisely defined by more precise data points—moneme or word by word vocal variations—that are easier to compare to find unique/idiosyncratic meta-patterns. Our system places these individual words in a framework database, so that over time, when it reaches about 50% completion, or 2,000 words. As a comparison, the average 8 year old knows 10,000 words in their native language, and average adult knows 25-35K words in their native language, over the course of 20 conversations, which our system can database every unique word spoken by a user at the time of conversation, a typical user will have employed well over 2,000 unique words. For a standard detailed model, a sample of 100 words would be sufficient, and our system generates a machine-use model once it has 2,000 individual data-points. This is so it can then replicate the unique vocal imprint of a User so that over time it can model its own machine speech on that user, so that that User's receivers can also hear their voice (at a level of perceptual “reality”) speaking the translated monemes or words in the Receiver's language. As a key part of a message's credibility and also message is the meta-communication of its sender's own self and personality, we see this normal function of our new machine language system as an important one to share, though it serves to support the core function of active voice translation and delivery for gapless conversation—versus segmented message transfer—between two individuals speaking two different languages.

Additionally, while our unique system and method translates both linguistic and paralinguistic meaning as heretofore described, it also, once a complete voice model is created for a User, then also transmit the specific paralinguistic, emotional messages of individual conversations. For example, while we have mentioned how out system models the unique vocal or speech patterns of the individual user, around unique but general tonal and pitch elements of that user, that is also in the aggregate. Like a baseline. However, humans change pacing, and make tonal and pitch shifts—often unconsciously—while speaking to convey primarily emotional meanings of humor, anxiousness, sadness, and fear around the specific linguistically framed content of their messaging. This is the additional in-statement information our system transfers during specific conversations to best translate total meaning in message.

### BRIEF DESCRIPTION OF THE DRAWINGS

The following drawings further describe by illustration the advantages and objects of the present invention in various embodiments. Each drawing is referenced by corresponding figure reference characters within the “DETAILED DESCRIPTION” section to follow.

FIG. 1 is a diagram showing two individuals who speak different languages using our systems and methods with input speech recognition, translation and machine speech output running in tandem on similar timelines so that to enable a gapless conversational loop.

FIG. 2 is a block diagram depicting one embodiment of our systems and methods with one of its users to show how our hardware machine simultaneously converts input to output as the User is speaking.

FIG. 3A is a diagram depicting one embodiment of our systems and methods showing how one User 1's speech input is serialized and how our system both receives speech input while delivering through machine speech. translated speech output to a receiver, User 2, in their language while the initial message is still being spoken by User 1 in User is language.

FIG. 3B is a diagram depicting the same embodiment of our systems and methods showing how one User 2 becomes a Sender from m being inside our same system as User 1 and responding spontaneously in their language while User 1 receives, via our system's machine speech the message in User 1's language, mirroring the same processes as shown in the prior figure, but from the second participant's point of view.

FIG. 4 is a flowchart depicting an embodiment of the serialized speech parallel process from human input to translated machine speech output, 900, focusing on the processing of the first and second word or monemes in a User's longer, ongoing spoken message.

### DETAILED DESCRIPTION AND FIRST EMBODIMENT

Introduction. The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

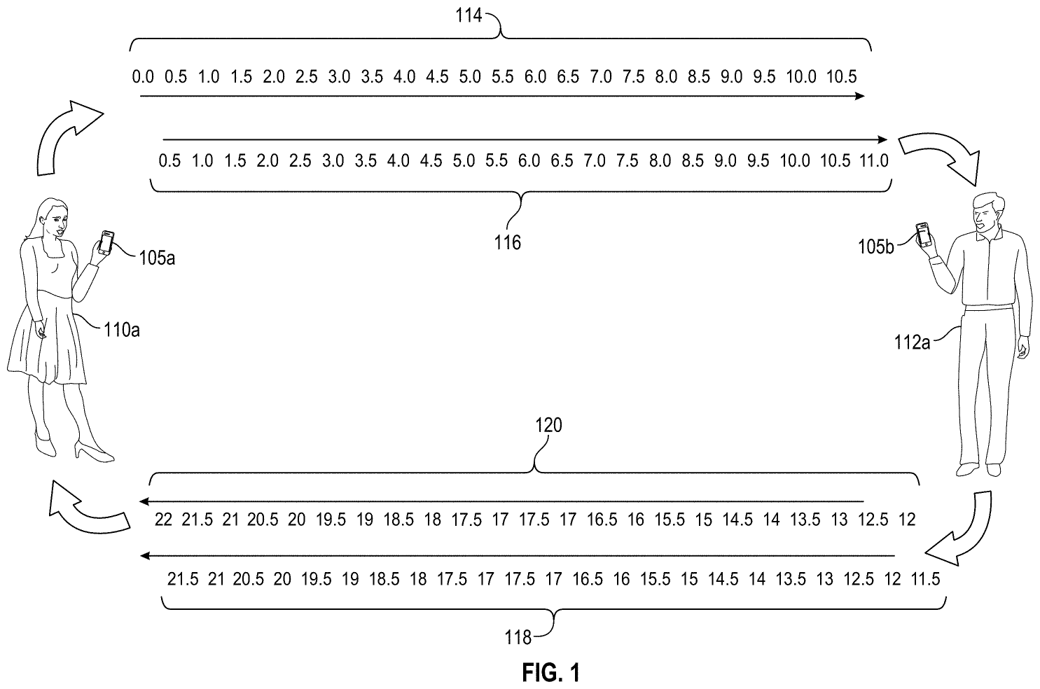

FIGS. 1-4 illustrate the core scenario in which a user devices 105A and 105B facilitate a conversational, i.e. interactive, direct and gapless communication, between two users both speaking different source languages and our system speaking in tandem with each user as live speech translator, in the target language of the other user, or for that point in time, in the “target” language.

The interaction in FIGS. 1-4 are described with reference to two primary users, who in a conversational loop through our system are at times both “sender” and “receiver” in what would in a standard model of communication be a linear point to point route. The user devices 105A and 105B can be, for example, a cellular or smart phone, a desktop or laptop computer, or even our own manufactured device since these devices are merely entry points into our system. These user devices allow immediate access to our system anywhere in the world but the primary requirement for them is an embedded speaker and microphone, wireless transmitter, and power access if not own source, as the components for much of our system's core unique functionality, are proprietary hardware, though not necessarily so.

FIG. 1 is an illustration showing the general communication advantage our system and method in enabling a continual conversational loop between two or more people, from any location, and its parallel processing enabling of two in-tandem and concurrent speech streams, that is, original language input and target language output, with approximate time-duration for both individuals' contribution to the first conversational loop.

As you can see, in FIG. 1, 110A, User 1 is holding a terminal for input into our system, and her original speech signal is shown going from left to right, as data stream 114. However, as our system serializes and dual-processes (recognizes, text translates, converts to translated speech via machine speech) every word separately as it is being spoken, and starts delivering as speech each word as the following word is being spoken in originating language, the second data stream, 116, is shown active concurrently with 114. So, if User 1, 110A, starts speaking into terminal 105A at zero point, by 0.5 seconds, the system is already translating the first input word in this example by 0.5 seconds, and completes translation by 1 second, which is why on the machine language out′data stream 116 “starts” at 0.5 seconds. User 1, 110A, continues speaking, and our system continues to parse, identity, convert, translate, and then produce translated speech output for the second word on a second processing stream, as the first word has already been delivered, and the third word User 1, 110A is speaking is already being translated, and so on until User 1, 110A completes whatever she wants to say—sentence to paragraph length. As far as ceiling of length of speech translation, with our system, a User could even be providing a 10 minute Shakespearian monologue as the processing strain across two sets of processors at one word per cycle is much lower than a single batch of 30 words such as with prior speech translation systems and so can run almost infinitely, constrained by terminal power and human physical duration, and attention span of a listener, e.g. User 2, 112A. Please note that 114 ends at 10.5 seconds, whereas 116 ends at 11 seconds. 0.5-1 second is the approximate lag time between User 1 speaking their initial word and our system's machine speech output of the last translated word being delivered to User 2, 112A. From a human communication framework, this is a nominal almost imperceptible “lag time” between input and output, and this is why User 2, 112A, can respond immediately to User 1, 110A, as our system has made it possible for him to (mentally) process the content or meaning of User 1's speech as translated speech in while User 1 has been speaking, as opposed to prior speech translation systems where he would have to wait to hear a separate translated speech after another User has spoken in a different language.

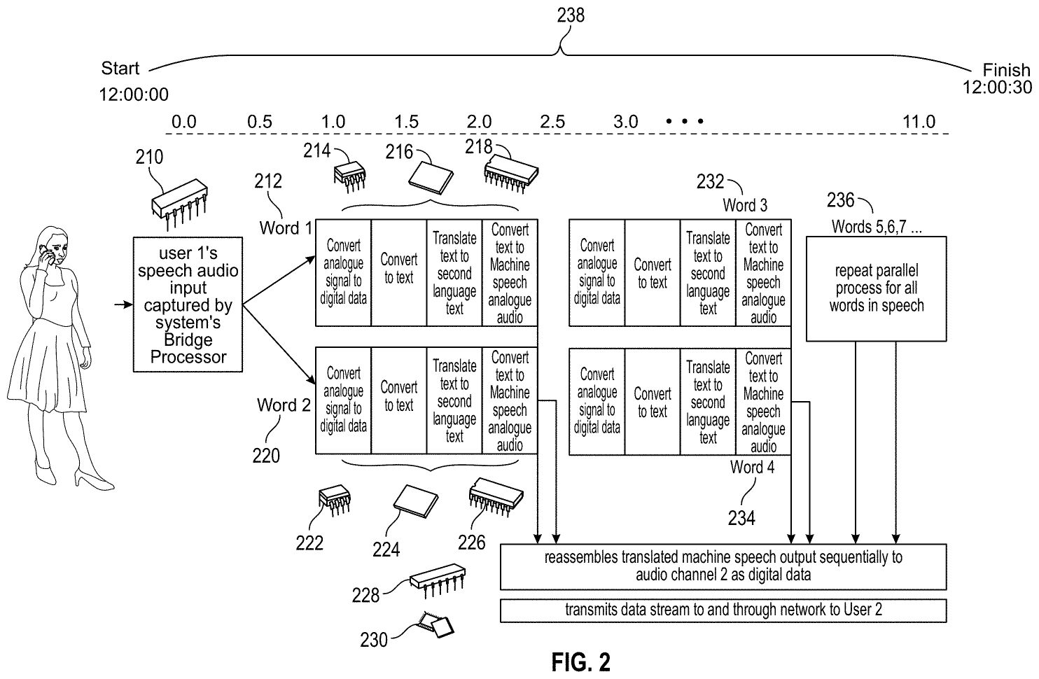

Our system and method as embodied in a hardware machine detailed by one participant's use as illustrated in FIG. 2 showing a User 1, 110B, speaking into a mobile terminal. Our system receives this analogue speech input data into a Bridge Processor, 210, as a stream, and parcels out each word in order it receives them back and forth to two different sub-systems in order to continually convert and deliver translated machine speech at the pace of the originating sentence so that it can be received as fluid conversational speech versus individual words separated with pauses. Therefore, when a speaker, here shown as 110B speaks into the terminal, analogue sound date passes through bridge processor 210, then the first word is sent to our system's Analogue-to-Digital processor, hereafter referred to as A/D Processor, where it is converted into digital data, then to processor 216, where it is converted to text in the originating language, then translated to text in the second target language, then this text is converted to audio through our machine processor 218, before going to our second bridge processor 228 that then reassembles an analogue audio stream as each word is received into the bridge processor 228, and then sent off terminal through the wireless transmitter 230. But as word 212 is moving through this processing, word two, 220 is already being sent from Bridge Processor 210 to A/D processor 222, translation processor 224, and text to machine speech conversion at processor 226, then through processor 228 and as the second word in the stream that 230 wireless transmitter has already initiated sending, as the next word in the stream. And so on, as Word 3, 232, is sent from bridge processor for input, 210, word 4, 234 is moving through bridge processor 210 and in route to A/D processor 222. This bridge parceled dual-processing individually parceled word data, processed, and reassembled data stream continues, as shown in box 236, for as long as User 110B continues to talk.

Based on our systems individual speech data—at the word or moneme level—recognition and translation but faster continual speech output, it can pace directly with a normal human conversation. The average length for an individual's individual message contribution in an interactive conversation is approximately 30 words, so in this case, we show the total time, in seconds, from User 110B's first word input to last machine speech output at 11 seconds across the timeline 238.

It is important to note here that as our system already has its own internal analogue to digital converters, 214 and 222, language translation processors, 216 and 224, and even on-board speech modeling to convert translated text language from 216 and 224 to machine speech modeled sound at 218 and 226, respectively, and that all processors have their own memory for storing recent data input and output typically for at least a few cycles worth of recent processing, colloquial referred to as “scratch” memory, our current system—without augmenting any individual component or major process, with simply added memory at current components, could record user voice data in an overall vocal imprint map (as a database) so that over time, as the total map is being completed, the specific machine speech's voice can be augmented (updated as a more complete model of the user's voice is created over time with variations across words and monemes and phonemes for specific pitch, tone variations specific to their own voiceprint) so that our systems specific machine speech on their behalf, regardless of output language, can replicate, with precision any User's, such as 110B's, exact speech pattern. For example, is the user in FIG. 2, 110B, speaks in English, idiosyncratic qualities of her voice can be gleaned from every (English) word she speaks, and over a few hundred 30-40 word contributions, regardless of translated output language and speech, a close model of User 110B's voice will be stored in our system's own database attaches to 218 and 226, or optionally with bridge processor 228 if a User should opt for speech to speech vocal modulation. Either way, even if an ongoing conversational partner through our system, such as User 112A, who will be shown in the next Figure to be a French speaker, User 110B's own voice imprint model will be perfected over time independent of how it is spoken post-translation. Over several conversations with User 112A, that User will recognize a shift in the general tone and pitch and other related vocal characteristics of our system's machine speech (on behalf of User 110B), as it more closely resembled 110B's real vocal pattern. To User 112B, it will sound as if User 110B is speaking French fluently in “her voice”, but of course, unless User 112A speaks to User 110B in person he will not recognize it as her “real” voice, and unless User 112B can also speak English, he will not understand User 110B is not a native French speaker until a face-to-face meeting.

More importantly, at the point our system has “learned” User 110B's voiceprint and can use it in its own machine speech to the point of where it sounds like her “real” voice as mentioned previously, should User 110B start using our system to talk to her friend Sharat, a native Hindi speaker, the “first” time User 110B uses our system with Sharat, as it will have already started modeling its own speech output on the updating model of her voiceprint, it's Hindi speech will sound—at the very least-feminine, and closer to 110B's own “real voice” from the first time she and Sharat converse through our system. Of course, since all Users in our system are both sender and receiver, and as our system is activated by use, and thus has “automated” speech recognition and modeling based on its core function, it will develop a more exact voice model for all users, from User 112A to 110B's friend Sharat once he comes into the system as a conversational member.

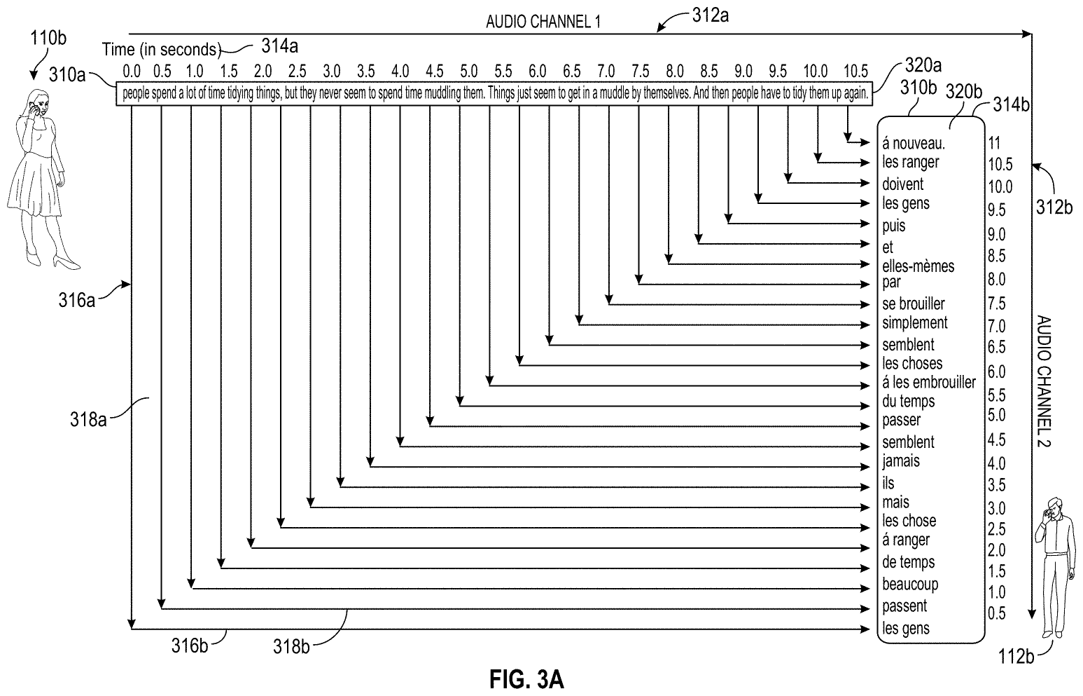

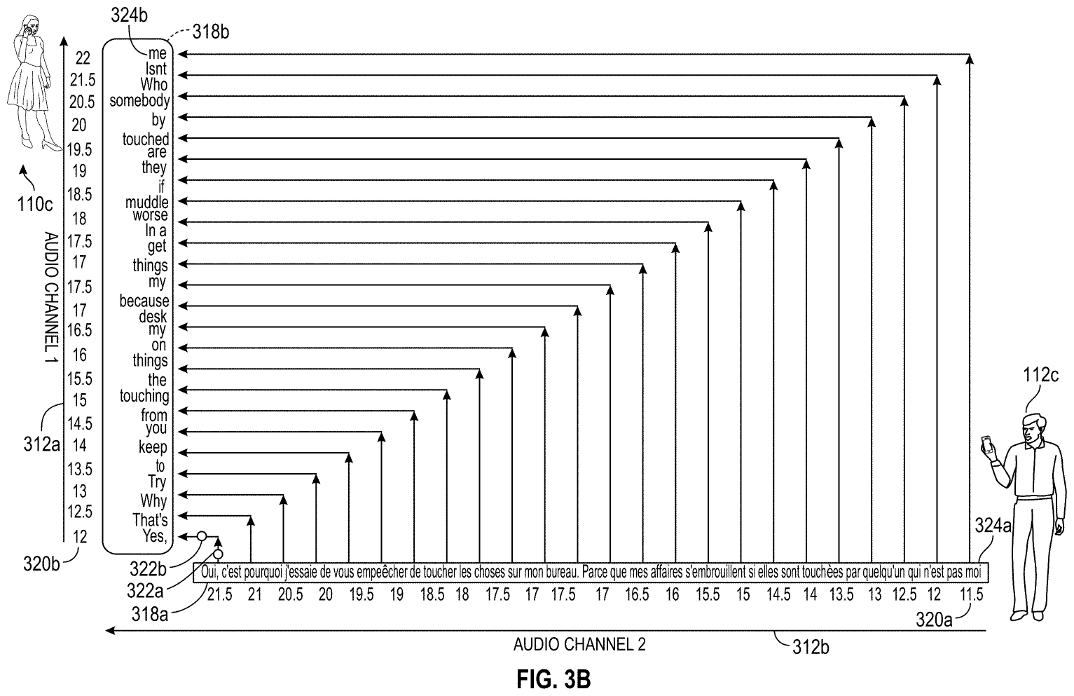

FIGS. 3A and 3B show the conversational loop of our system as depicted broadly, but in whole, in FIG. 1, but specifically from a word by word speech input, translation, and speech conversion to output perspective.

FIG. 3A shows User 110B, and as in FIG. 2, initiating a conversation through our system to User 312B. User 110B says, as shown in block 310A “people spend a lot of time tidying things, but they never seem to spend time muddling them. Things just seem to get in a muddle by themselves. And then people have to tidy them up again.” This is translated and spoken by our system in machine language to User 112B in his native language, French, as “les gens passent beaucoup de temps a ranger les chose maid ils jamais semblent passer du temps a les embrouiller les chose semblent simplement se brouller par elles-memes et puis les gens doivent les ranger a nouveau.”, as shown in block 310B.

As out system is translating and delivering moneme by moneme or word by word as they are being spoken at conversational speed, in this case, from User 110B to User 112B, our system uses one audio channel, 312A, for User 110B's speech input, and another audio channel, 312B, for machine speech output in French to 112B, so that neither channel creates “noise” for the other as much of the time both User 1 and Machine will be speaking at the same time as User 2 is listening. [00128] Furthermore, while both speech input and speech output streams, over audio channel 1, 312A, and audio channel 2, 312B are spoken and heard as a series of consecutive words in a normal conversational stream, our system processes and delivers each word at a time, and reassembles the output words as speech sequentially in one audio stream to mimic natural speech pattern and aid in reception. For example, User 110B says “people” and our system receives and processes it, 316A, and send it as speech output (“les gens”) 316B, so that User 112B hears “les gens” in it in under 1 second, but then User 110B, who continues speaking normally without pause, says “spend” and our system receives and processes it, 318A, and send it as speech output (“passant”) 318B, so that User 112B hears “passant” approximately 1.5 seconds into the conversation. User 110B conveys one idea, which happens to contain 3 sentences, of varying length to accomplish that, which in this case, is measured at normal rate of conversation, at 10.5 seconds to complete as per the timeline 314A. However, as our system already started delivering translated speech to 112B at approximately 1 second from when User 110B started talking, when User 110B finishes talking at approximately 10.5 seconds, with the last words, 320A, being “again”, only a total of 11 seconds between both conversational partners through our system, 110B and 112B, have passed as User 112B hears the last words in the French machine speech stream, of “a nouveau”, 320B. Our system, but use of parallel—but integrated—processing from translation through machine speech output essentially allows its Users, as speakers to speak “directly” in another language (through our machine language), so uniquely, there is no waiting gap between original language speech segment and translated speech segment, and so that a receiver, such as 112B can process the meaning of what 110B is saying while she is saying it, and so can respond almost immediately as soon as she has finished, in this case, without waiting another 11 seconds to hear a translated set of speech after User 110B has spoken. This is how out system is uniquely enable true real-time conversation between two individuals speaking two different languages. [00129] FIG. 3B is an illustration showing the second part of a conversational loop our system enables, as described in FIG. 1 which shows a French speaking User, 112C, directly responding to User 110B, here as 110C as the user is shown as a receiver/listener, instead of a speaker/sender as in FIG. 3A. To show a “direct” response, the timeline 320A starts at 11.5 seconds into the conversation, more specifically, this complete loop in a larger conversation. This loop lasts in total 21.5 seconds, and is composed of both Users as speaker/sender and listener/receiver. The figure also shows User 112C having his own dedicated audio channel, 312B, for which he had heard French machine speech from our system in FIG. 3B, and now over which he speaks into our system, shown here directionally from right to left over audio channel 2, 312B. Our system works exactly the same as shown in FIG. 3A, with User 112C's first spoken word being “Oui” spoken at 11.5 seconds (from the start of the overall conversation as depicted in FIG. 3A), and received as “yes” from our system's machine speech by the 12th second of the conversation by User 110C. For ease of comprehension, we've listed User 112C's own speech from left to right, as is the western convention, while the timeline 320A counts up from right to left from 11.5 seconds to 21.5 seconds, when User 112C completes his last word, “moi” 324A, which is heard in English through our system's machine speech as “me”, in English, by User 110C as “me”, 324B.

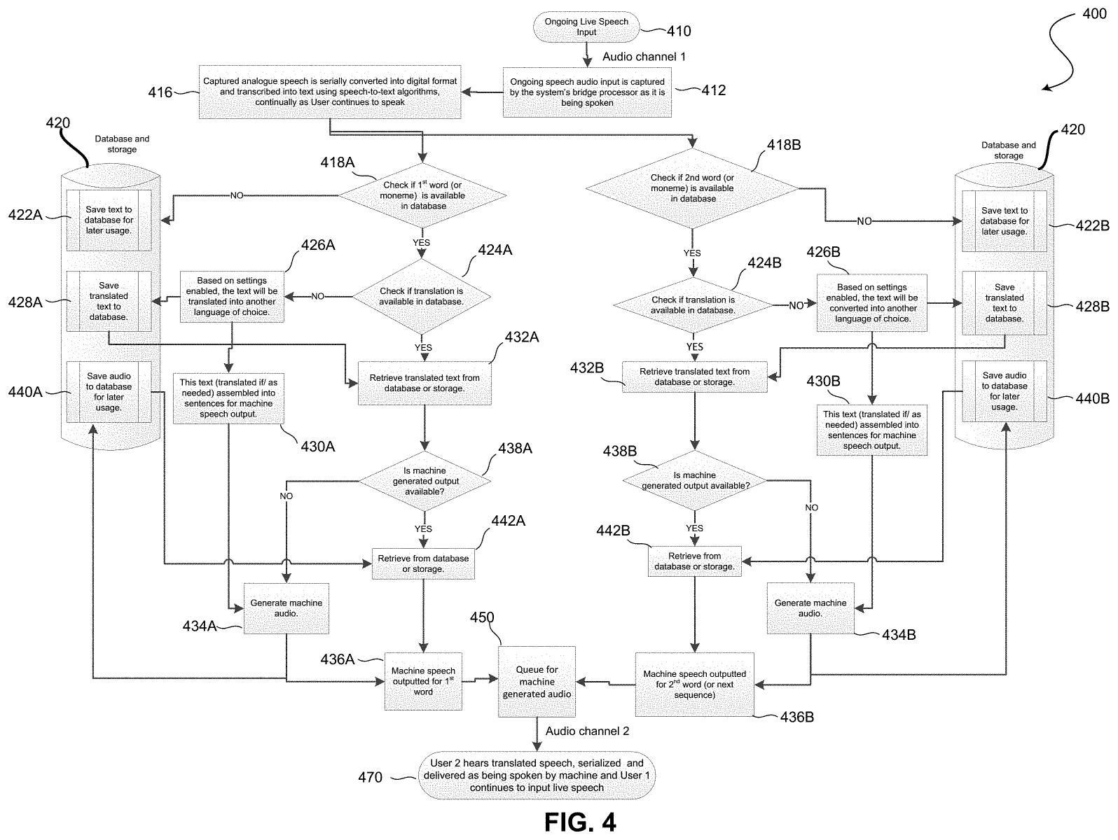

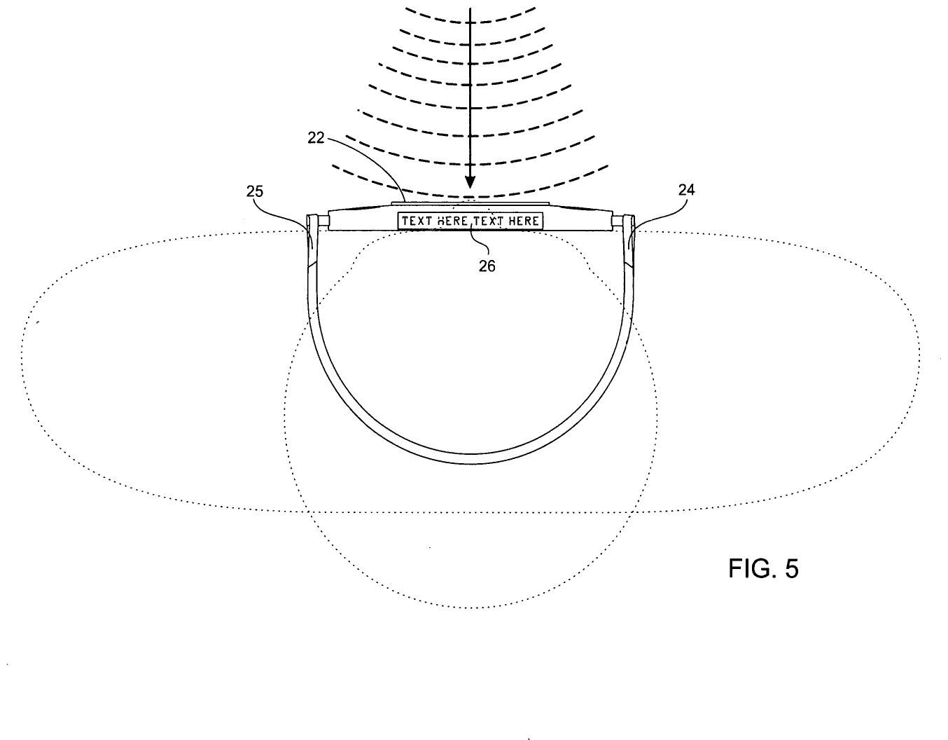

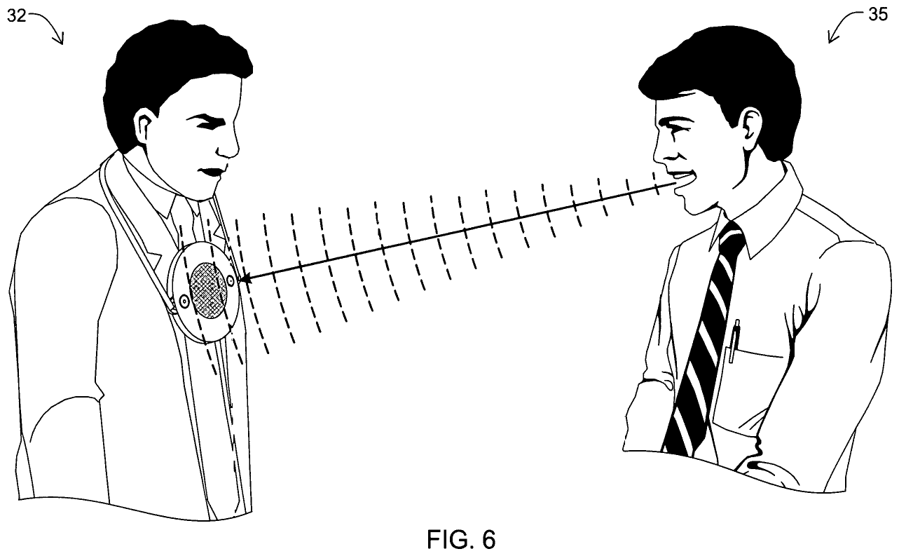

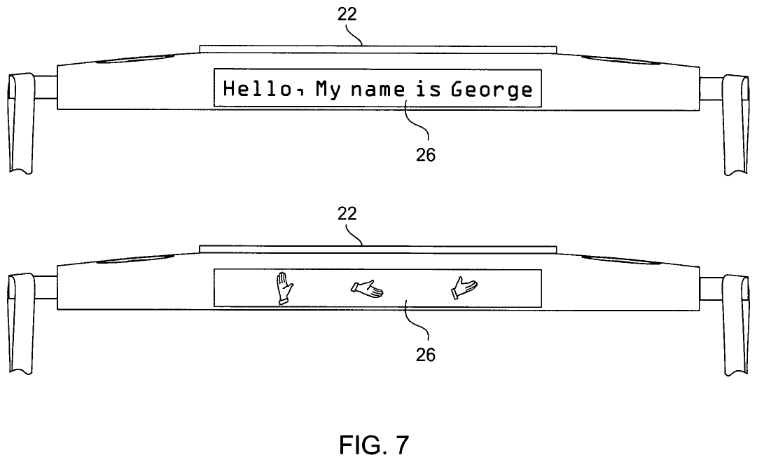

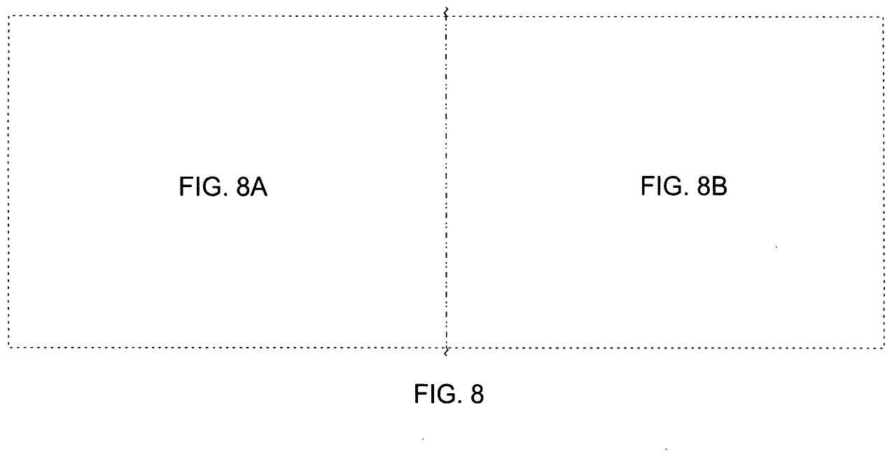

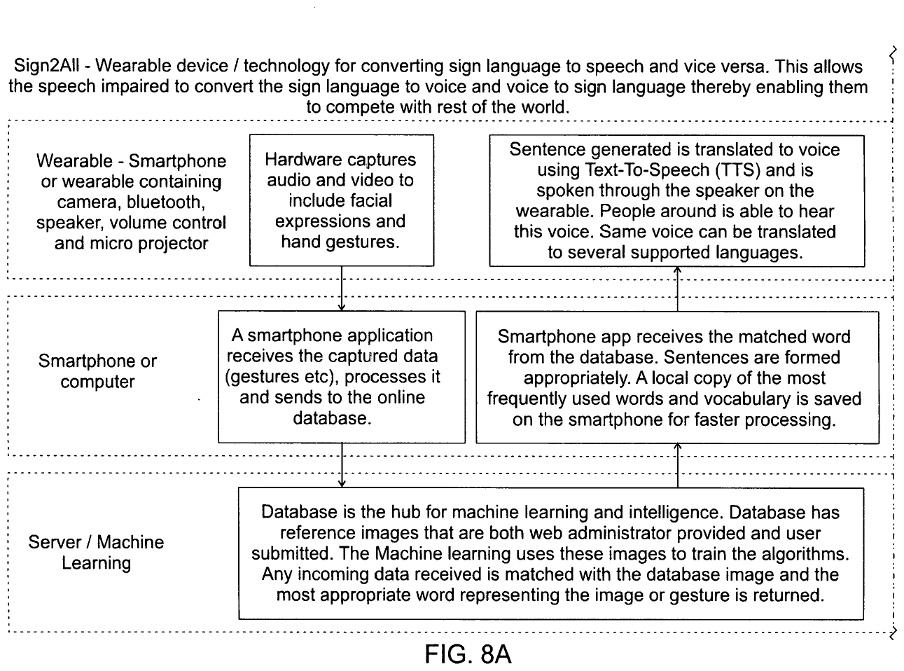

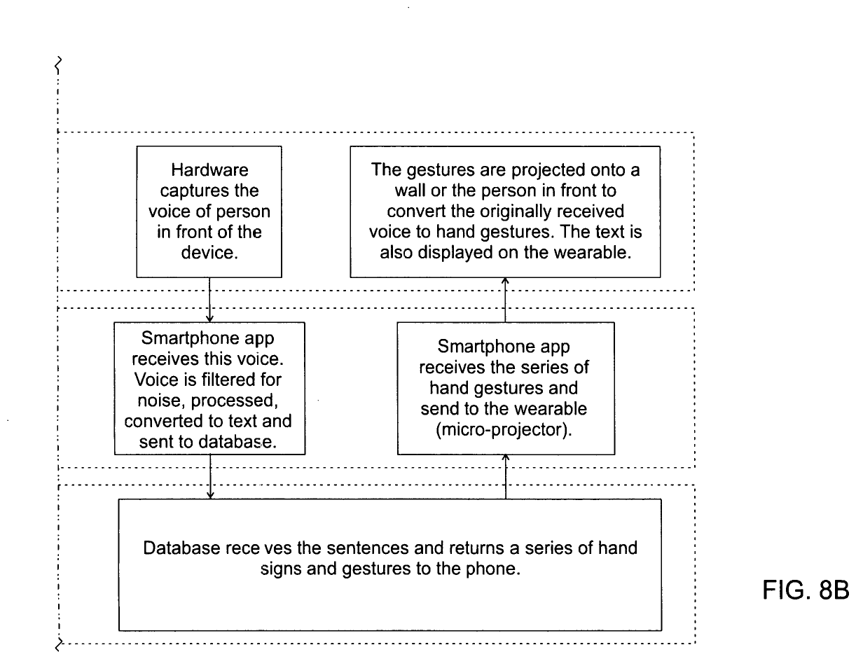

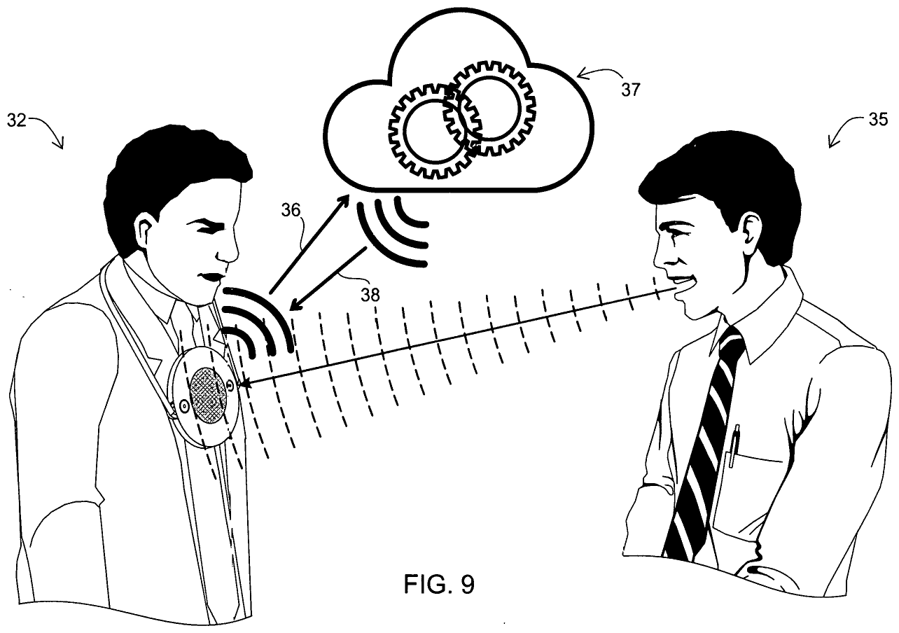

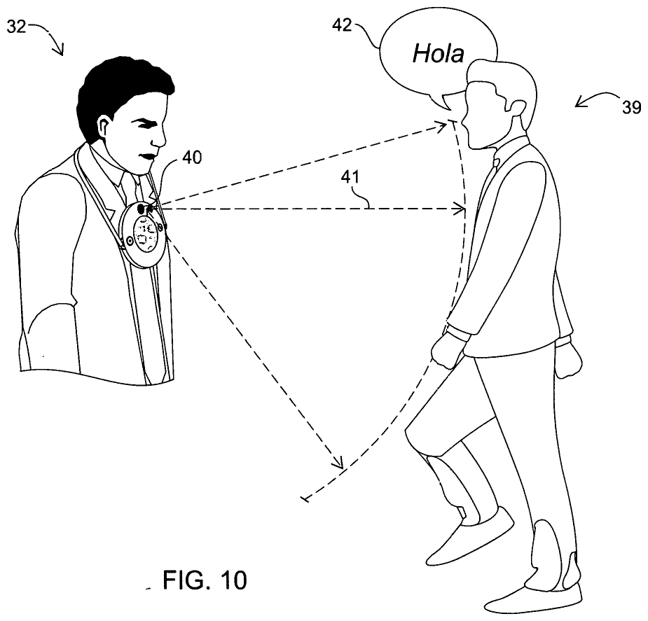

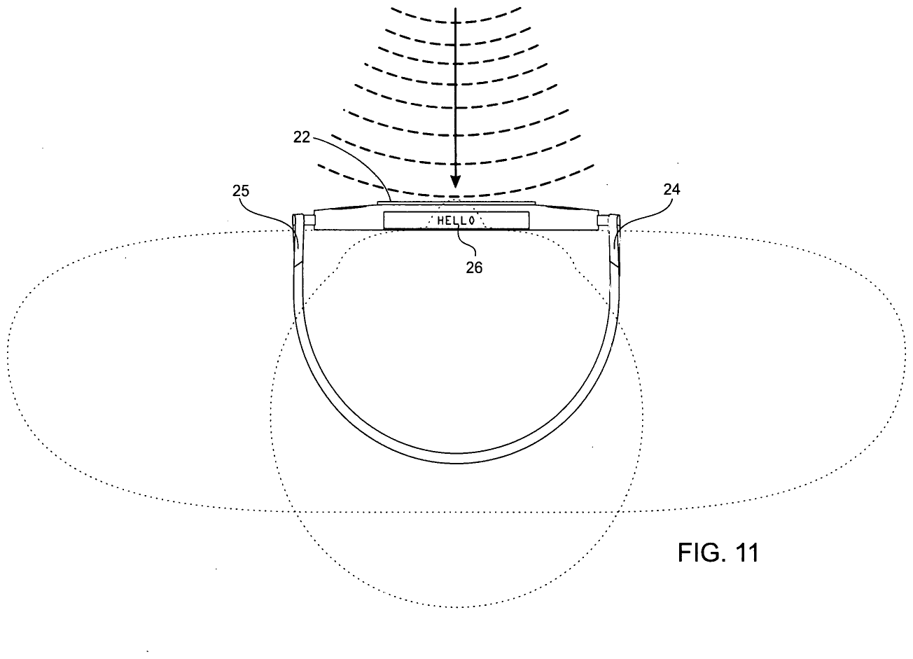

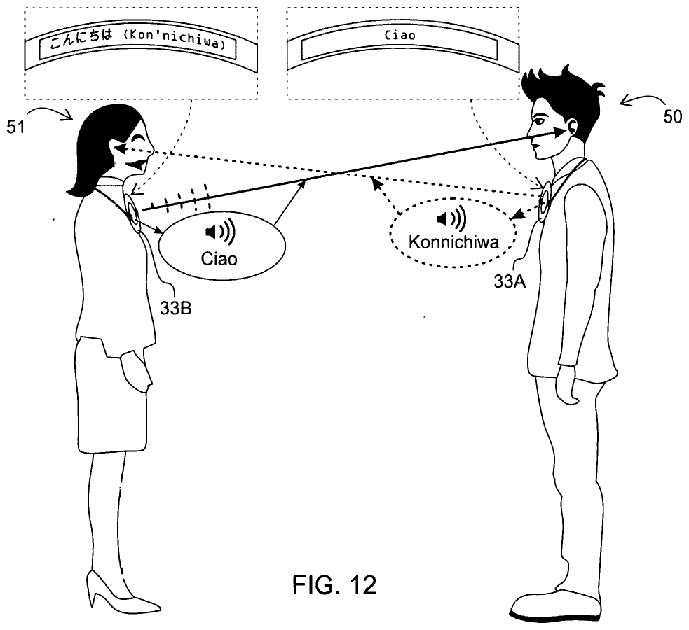

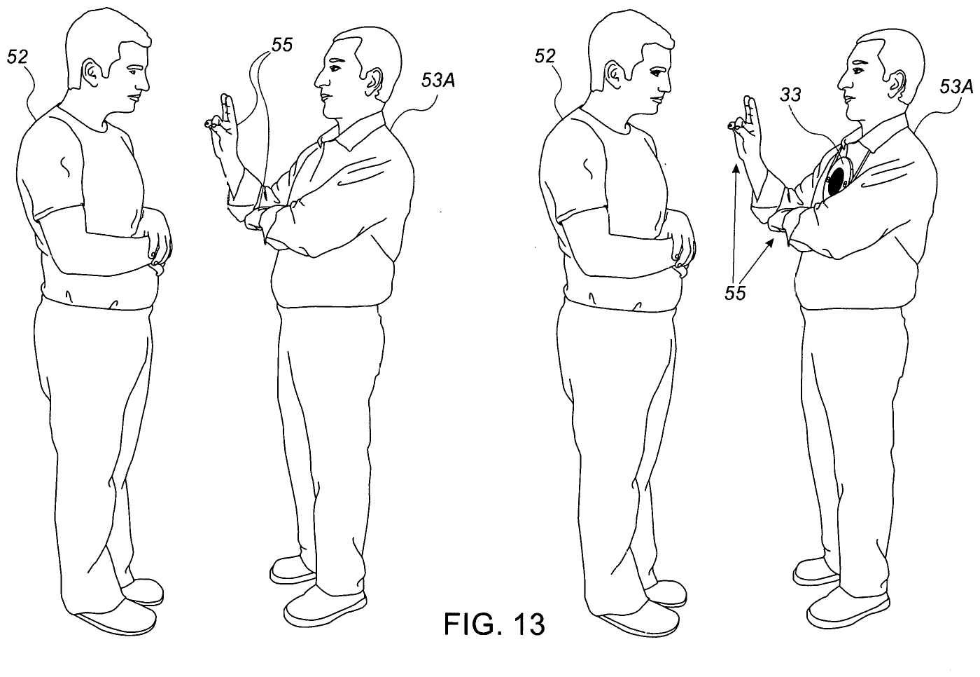

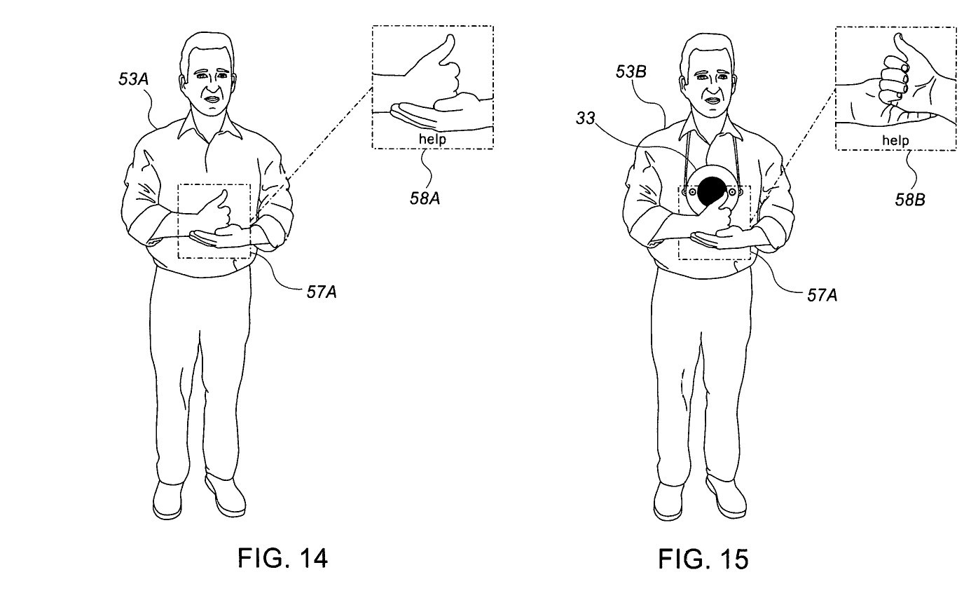

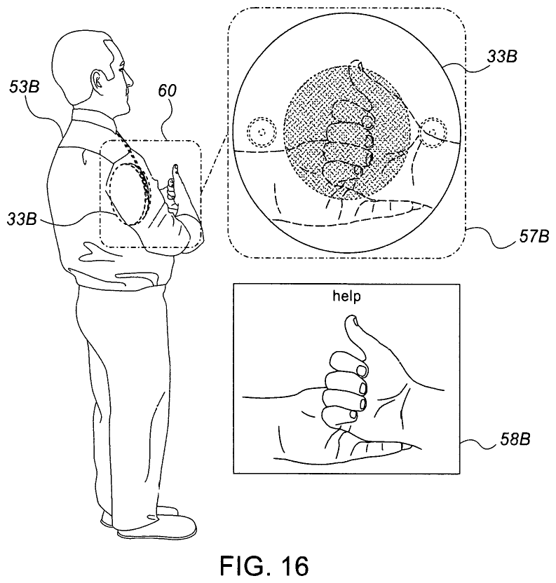

FIG. 4 is a flowchart depicting an embodiment of the serialized speech parallel process from human input to translated machine speech output, 400, focusing on the processing of the first and second word or monemes in a User's longer, ongoing spoken message, such as User 110 in FIG. 1 communicating with second User 112. In our system and method, when a user speaks into our system, the speech is received live at 410 and in through one audio channel into a bridge processor at 412, and is immediately entered into the translation process 400 as the User is still speaking. So as the User is speaking into the system at 410, and this audio is being captured by the bridge processing, that processing is continual and continually flowing from 412 to 416 where it is converted from analogue speech data to digitized text. From there, the first word or moneme (depending on the smallest unit of meaning per input or output language) enters into process A, at 418A where it is checked against database 420 to see if it is already in the database 410. If it is not, the text is saved in the database storage 422A for later use. If it is in the database, then the system checks to see if the translation is already available at 424A, if it is not, based on the user setting enabled, text will be translated into a second language of choice, 426A, and saved as translated text as step 428A. If the translated text is available in system's database 420, is available as translated text, it is pulled and received at 432A, and our system then checks to see if machine generated output is already saved in storage and available for output at 438A, and it is retrieved from database storage in 442A. Then, for this first word or moneme, machine speech is outputted for the first word at 436A, and in queue for machine generated audio output at 450. In addition, if the translated text is multiple words, such as a moneme, or smallest unit of meaning is more than one word, at 430A these multiple words will be reassembled into grammatically correct sequencing at 430A, then our system generates machine audio from that reassembled set at 434A before our systems machine speech is outputted for the first word or word set at 436A and then placed into queue for machine generated audio 450.

The total time for this process to be completed is approximately a few milliseconds, but it is discretely processed since individual words or monemes have to be outputted in sequence at 470 as the User/Speaker continues to speak into the system at 410 and as it is continued to be processed live at 412.

Ergo, within milliseconds from word one or moneme one is going into our systems process A through 416 and 418A, the second word or moneme being spoken into the system at 410 is being processed by the systems bridge processor at 412, converted to digital text at 416, but then into a second parallel process running in tandem to Process A, but as Process B at 418B. It is the same process as shown for word or moneme one. This means the second word or moneme at 418B is checked against database 420 to see if it is already in the database 410. If it is not, the text is saved in the database storage 422B for later use. If it is in the database, then the system checks to see if the translation is already available at 424B, if it is not, based on the user setting enabled, text will be translated into a second language of choice, 426B, and saved as translated text as step 428B. If the translated text is available in system's database 420, is available as translated text, it is pulled and received at 432B, and our system then checks to see if machine generated output is already saved in storage and available for output at 438B, and it is retrieved from database storage in 442B. Then, for this first word or moneme, machine speech is outputted for the first word at 436B, and in queue for machine generated audio output at 450. In addition, if the translated text is multiple words, such as a moneme, or smallest unit of meaning is more than one word, at 430B these multiple words will be reassembled into grammatically correct sequencing at 430B, then our system generates machine audio from that reassembled set at 434B before our systems machine speech is outputted for the first word or word set at 436B and then placed into queue for machine generated audio 450.

This is an ongoing dual process, so as word or moneme one and word or moneme two are moving through our systems processing A and B, respectively, the next words being spoken live through 410 have already moved through bridge processing 412 and been converted to digital text at 416, then also move through process A and B, for example word or moneme 3 and word and moneme 4 from speech input 410 are moving through process A and process B respectively, and as our system can dual process and machine output words in cue at 450 faster than normal human speech at 410, with organic speech pauses, as all of these words, in sequence, are cued in order at 450, they are output as machine speech audio at 470 in normal speech pattern flow for a second user to hear in their language, but while a first user is still speaking their message through 410. So that when a human speaker completes their conversational speech, which is on average 30 words at 30 seconds for a normal conversational contribution, the machine speech output will have completed the same message in the other language so that the User 2 has heard, at 470, the entire spoken message in machine audio within a second after User one has spoken it at 410.

To avoid generating noise in providing machine speech output at 470 while the human speaker is speaking into our system at 410 almost simultaneously, we have noted that our system always utilizes two separate audio channels, such as audio channel one for input at 410 and 412, and audio channel two for output at 450 and 470.

### OBJECTS OF THE INVENTION

Introduction. Accordingly, several advantages and objects of the present invention are:

A principal object of the present invention is to provide a means for two individuals speaking two different native languages to converse in real time without typical translation or delivery gaps through the use of machine segmentation and component processing, translation, and conversions into translated audio while original language message is still being spoken, so that when one person finishes speaking on one language, the receiver has already heard their message, via machine speech, in their language and uniquely already had time to process (mentally) the linguistical meaning so they can respond immediately, just like in a normal human face to face conversation.

As the primary and ideal channel is via mobile device, and as the system—by eliminating the processing drag and time gap of batch processing as is standard with all current translation technology—it can also be used uniquely by two individuals at the same time as opposed to the standard linear input, translation delivery, then receiver having to use their own system to do the same in return. This allows for our system to be automatically closed to all excepting the two members in the conversation, so that all information can be automatically encrypted and decrypted, though not apparent to either users in a conversation, if transmitted via wireless or wired channel, even though a translation engine, any in-transit information will be undecipherable to a person who has access to a public point, such as a translation engine server, but the receiver, within our system hears speech in their own language without having to manually decrypt the data as it is being delivered from the system to that single reception point.

Another object of the invention, based on its pre-componentized speech monemes or words, is to be able to repurpose those audio components to learn by placing each unique component in a voice model mesh/database, the specific and unique imprint of its user. This way, over time, as the system has received enough data-points (about 2,000 spoken words), it can then model its own machine speech on behalf of the User to sound perceptively replicated and be used as the machine's speech when delivering translated speech to individual's in their language that the User 1 chooses, but in “their” voice.

In addition, once a User voice imprint model is complete, it can be used as a rapid filter to capture pitch, tonal, and pacing changes unique to a User's specific conversation, to be able to transmit those emotional or paralinguistic cues or messages to a receiver at the time of this conversation.

Furthermore, based on the general processes of our system, and the ease in repurposing componentization necessary for its translation, as the unique tonal and pitch characteristics of a User's voice imprint model can be used as an always on reverse filter, should the system be used in a mobile computing environment, it can also be used to eliminate ambient noise in public areas should a User desire to have a close face to face conversation that necessitates speaking at a distance from a mobile phone and holding it equidistant from a conversational partner to hear and input as well.

1. A device worn by a speech-impaired signer behind both of their hands approximately mid-torso based on natural hand position for sign-language communication, which tracks both of their hands and records gestures from behind said hands, before said device uses its own in-system database of behind-the-hands perspective correlative gestural images to map the captured images to standard front-of-hand sign language dictionaries via a machine-learned model that is trained using multiple similar images per word i.e., convert the visual analogue data to digital data, to text-based language, and outputs in machine speech, through the device via a wireless method such as wi-fi to a second person's smartphone or similar device, or via an embedded speaker on said device, to communicate with other people whose primary input/output communication mode is verbal,

2. The device of claim 1, wherein the device can receive voice from another human and translate it to symbolic data displayed on the top of the device via an LCD panel, for the wearer to read on the device,

3. The device of claim 1, in which the text or symbol display on the device is touch-activated, so that sentences or symbol strings can be paused by the user.

4. Furthermore, the touch-screen display of claim 3, by which a user can double-tap on an individual word or symbol to request further definition via the device system's database.

5. The touch-screen display of claim 3, in which after an individual selects a word or symbol for further definition and receives it, can tap the touch-screen device to restart the text to continue moving.
